(19) United States
(12) Patent Application Publication
(10) Pub. No.: US 2015/0120462 A1
(43) Pub. Date: Apr. 30, 2015

(54) Method And System For Pushing Merchandise Information

(71) Applicant: Tencent Technology (Shenzhen) Company Limited, Shenzhen (CN)

(72) Inventors: Tao ZHANG, Shenzhen (CN); Feng Lu, Shenzhen (CN); Shunfu Ye, Shenzhen (CN); Chen Tao, Shenzhen (CN); Lichun Li, Shenzhen (CN); Hongmin Zheng, Shenzhen (CN)

(21) Appl. No.: 14/588,828

(22) Filed: Jan. 2, 2015

Related U.S. Application Data
(63) Continuation of application No. PCT/CN2014/084679, filed on Aug. 19, 2014.

(30) Foreign Application Priority Data
Oct. 29, 2013 (CN) 201310522032.3

(51) Int. Cl. G06Q 30/02; G06Q 20/12

(52) U.S. Cl. CPC G06Q 30/0267; G06Q 20/12
USPC 705/14.64

(57) ABSTRACT

Method, system, and terminals for pushing merchandise information are disclosed. The method includes: at a server: receiving first identification data from a first client device, wherein the first identification data is acquired by the first client device from a first merchandise item; establishing a first association between the first merchandise item and a first user account of the first client device; generating second identification data for the first association between the first user account and the first merchandise item; receiving the second identification data from a second client device; and in response to receiving the second identification data from the second client device, establishing a second association between a second user account of the second client device, the first merchandise item, and the first user account.

### PRIORITY CLAIM AND RELATED APPLICATIONS

This application is a continuation application of PCT Patent Application No. PCT/CN2014/084679, entitled “METHOD AND SYSTEM FOR PUSHING MERCHANDISE INFORMATION” filed on Aug. 19, 2014, which claims priority to Chinese Patent Application No. 201310522032.3, entitled “METHOD AND APPARATUS FOR PUSHING MERCHANDISE INFORMATION,” filed on Oct. 29, 2013, both of which are incorporated by reference in their entirety.

### TECHNICAL FIELD

The present disclosure relates generally to the field of Internet technologies, and in particular, to method and apparatus for pushing merchandise information.

### BACKGROUND

Along with development of the mobile communication technology, mobile terminals, such as mobile phones, have become very important tools in people's daily work and life. Installation of various applications in the mobile phones brings great convenience to people's life.

With the growing number of mobile phone users, pushing of merchandise information to people for the purpose of promoting products and services also changed from a conventional pushing mode to a pushing mode related to the mobile phones. In the conventional pushing mode, picture advertisements are displayed by billboards or stands occupying a certain areas (e.g., on the store window or near the merchandise on sale), or information including sounds or images of products is displayed by multimedia (e.g., on TV or audio/video broadcast in store). But in a mode of pushing the merchandise information by a computer or a mobile phone, commonly, after interest data of users is acquired (e.g., via user's demographic data and/or online search or browsing history), targeted merchandise information corresponding to the interest data is pushed to individual users via the Internet. By targeted pushing of advertising information, user groups to which certain merchandise information is pushed are more accurate and the advertising effect is better.

However, in the existing merchandise information pushing method, the acquired user data is daily use operation habits, so that if there are multiple users using the same computer terminal, the pushed information cannot have high accuracy due to different use habits and interests of the users. This is wasteful for both the merchant and the users who receive merchandise information that they are not interested in.

### SUMMARY

In the present disclosure, a method and system of pushing merchandise information is disclosed. Unlike in existing information pushing techniques, where the online advertising information is aimed to promote product and services such that the user can be motivated to make online purchases or seek out the product and services offline (e.g., in a brick and mortar store), the techniques disclosed herein may help promote online sales by making use of offline activities, such as the user browsing in a local store, and interacting with a live sales person. By making it easy and convenient for the user to save product information for a merchandise he/she saw and inquired about in a store to a user account active on a mobile device, and allowing the store clerk to easily obtain customer information and associate the customer with the product(s) that he/she is interested in, the store clerk can help answer questions, offer additional incentives to promote the ultimate sale of the product to the customer online after the customer has left the physical store. The store clerk can be credited for the sale, and be more motivated to interact with the customer, and the customer can easily share the purchase experience and information with his/her social network to obtain discounts from the store.

In one aspect, the method for pushing merchandise information is disclosed. The method is performed by a server having one or more processors and memory. The server receives first identification data from a first client device, wherein the first identification data is acquired by the first client device from a first merchandise item; establishes a first association between the first merchandise item and a first user account of the first client device, the first association indicating an expressed interest of a first user of the first client device in the first merchandise item; generates second identification data for the first association between the first user account and the first merchandise item; receives the second identification data from a second client device; and in response to receiving the second identification data from the second client device, establishes a second association between a second user account of the second client device, the first merchandise item, and the first user account, the second association indicating an expressed interaction between a second user of the second client device and the first user with regard to the first merchandise item.

In some embodiments, the server, in response to receiving the first identification data from the first client device, provides first merchandise information corresponding to the first merchandise item to the first client device. In some embodiments, the server receives a user instruction from the first client device to save the first merchandise information; and in response to the user instruction, the server stores the first merchandise information in association with the first user account of the first client device for future user retrieval from the first user account.

In some embodiments, the server, prior to generating the second identification data, receives a user instruction from the first client device to generate the second identification data; and in response to the user instruction, provides the second identification data to the first client device for display on the first client device. In some embodiments, the second identification data is a 2D barcode, and the second client device acquires the 2D bar code by scanning the 2D barcode displayed on the first client device.

In some embodiments, the server detects an update on the first merchandise information for the first merchandise item; in response to detecting the update, determines that the first merchandise item is associated with the first user account based on the first association; and in response to the determining, provides the update to the first client device for future user retrieval from the first user account.

In some embodiments, the server receives a message regarding the first merchandise item from the second user account; in response to receiving the message, determines that the first merchandise item is associated with the first user account based on the first association; in accordance with the determining, forwards the message to the first user account.

In some embodiments, the server receives a user instruction from the first client device to purchase the first merchandise item; and in response to receiving the user instruction, coordinates a payment transaction for the purchase of the first merchandise item using a payment account associated with the first user account. In response to receiving the user instruction, the server determines that the first merchandise item and the first user account is associated with the second user account based on the second association; and in response to the determining, registers a credit for a second user of the second user account for the sale of the first merchandise item to the first user.

In some embodiments, a computer system includes one or more processors and memory storing one or more programs for execution by the one or more processors, the one or more programs include instructions for performing, or controlling performance of, the operations of any of the methods described herein. In some embodiments, a non-transitory computer readable storage medium storing one or more programs, the one or more programs comprising instructions, which, when executed by a computer system with one or more processors, cause the computer system to perform, or control performance of, the operations of any of the methods described herein. In some embodiments, a computer system includes means for performing, or controlling performance of, the operations of any of the methods described herein.

Various advantages of the present application are apparent in light of the descriptions below.

### BRIEF DESCRIPTION OF DRAWINGS

The aforementioned implementations as well as additional implementations will be more clearly understood as a result of the following detailed description of the various aspects of the technology when taken in conjunction with the drawings. Like reference numerals refer to corresponding parts throughout the several views of the drawings.

FIG. 1 is a block diagram of a server-client environment in accordance with some embodiments.

FIG. 2 is a block diagram of a server system in accordance with some embodiments.

FIG. 3A is a block diagram of a client device for a shopper in accordance with some embodiments.

FIG. 3B is a block diagram of a client device for a sales clerk in accordance with some embodiments.

FIG. 4A illustrate a merchandise (e.g., clothing) with a 2D code in a shop;

FIG. 4B illustrate the scanning of the 2D code of the merchandise by a client application (e.g., a social networking client application with an online payment function) installed on a client device of a shopper (e.g., the first client terminal);

FIG. 4C illustrates the reading and presentation of the merchandise information by the client application installed on the client device of the shopper (e.g., the first client terminal) through the scanned 2D code;

FIG. 4D illustrates a second identification (e.g., another 2D code) generated or presented by the client device of the shopper (e.g., the first client terminal) after a triggering action (e.g., a predetermined user input) performed on the client device of the shopper;

FIG. 4E illustrates a process for inputting identity information associated with a user of a second client device (e.g., a sales clerk holding the second client device) when the second identification presented on the client device of the shopper (e.g., the first client terminal) is scanned by the second client device of the sales clerk;

FIG. 4F illustrates dynamic information shown on the client device of the shopper (e.g., the first terminal) after the shopper has saved the merchandise information by scanning the 2D code of the merchandise;

FIG. 4G illustrates a pre-order action on the client device of the shopper (e.g., the first terminal) for the merchandise after the shopper has saved the merchandise information by scanning the 2D code of the merchandise;

FIG. 4H illustrates dynamic information (e.g., order confirmation and discount information) provided by the second client terminal to the first client terminal after the second client terminal (e.g., the client device held by the sales clerk) has associated the shopper with the merchandise by scanning the second identification generated by the client device (e.g., the first client terminal held by the shopper).

FIGS. 5A-5B illustrate a process for a shopper to obtain merchandise information and for a sales clerk to obtain customer interest information in a brick-and-mortar store, and follow up with shopping-related action (e.g., making a pre-order of product, & further follow-up and promotion of products) online afterwards.

FIG. 6 is a flow chart of a merchandise information pushing method according to some embodiments.

FIG. 7 is a flow chart of a merchandise information pushing method according to some embodiments.

FIG. 8 is a flow chart of keeping merchandise data statistics according to some embodiments.

FIGS. 9A-9C is a flow chart of pushing merchandise information in accordance with some embodiments.

FIG. 10 is a structural block diagram of a merchandise information pushing apparatus according to some embodiments.

FIG. 11 is a structural block diagram of mobile terminal for information pushing according to some embodiments.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

The following clearly and completely describes the technical solutions in the embodiments of the present application with reference to the accompanying drawings in the embodiments of the present application. Apparently, the described embodiments are merely a part rather than all of the embodiments of the present application. All other embodiments obtained by persons of ordinary skill in the art based on the embodiments of the present application without creative efforts shall fall within the protection scope of the present application.

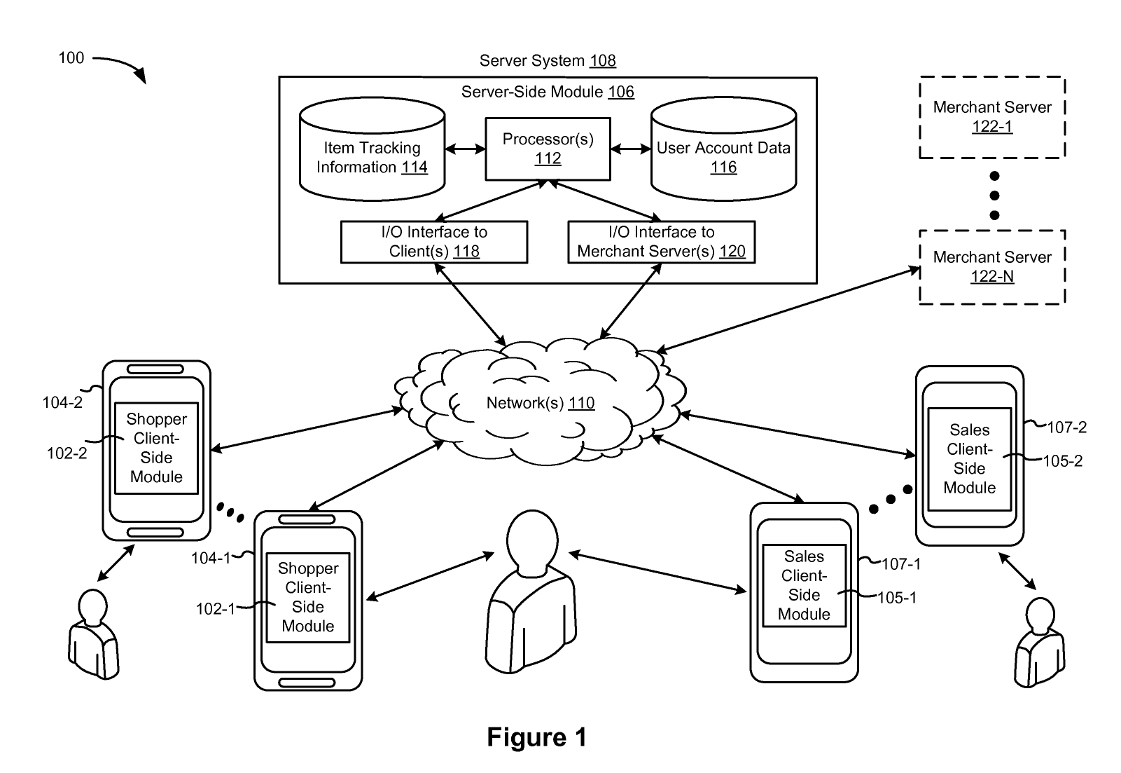

As shown in FIG. 1, data processing for a social networking platform is implemented in a server-client environment 100 in accordance with some embodiments. In accordance with some embodiments, server-client environment 100 includes a first type of client-side processing 102-1, 102-2 (hereinafter “shopper client-side module 102”) executed on a client device 104-1, 104-2, a second type of client-side processing 105-1, 105-2 (hereinafter “sales client-side module 105”) executed on a client device 107-1, 107-2, and server-side processing 106 (hereinafter “server-side module 106”) executed on a server system 108. Shopper client-side module 102 and Sales client-side module 105 each communicate with server-side module 106 through one or more networks 110. Shopper client-side module 102 provides client-side functionalities for retrieving merchandise information through actions offline (e.g., in a brick-and-mortar store) and performing online shopping based on the retrieved merchandise information, and communications with server-side module 106. Shopper client-side module 102 also optionally provides client-side functionalities for the social networking platform (e.g., instant messaging and social networking services, and sharing of the merchandise information). Sales client-side module 102 provides client-side functionalities for saving customer interest data through actions offline (e.g., in a brick-and-mortar store) and help a sales clerk facilitate online shopping (e.g., follow-up, and providing additional incentives, etc.) based on the saved customer information, and communications with server-side module 106. Sales client-side module 102 also optionally provides client-side functionalities for the social networking platform (e.g., instant messaging and social networking services, and aggregation of overall sales information). Server-side module 106 provides server-side functionalities for pushing the relevant merchandise information, generating identification data for the customer interest (e.g., associating a shopper and particular merchandise), associating sales clerk with the customer interest data, and facilitating the online shopping, payment, sale, and crediting the correct sales clerks for actual online sales for any number of client modules 102, 105 each residing on a respective client device (e.g., client devices 104, 107). Server-side module 106 may also provides server-side functionalities for the social networking platform such as instant messaging and social networking services and/or payment processing for any number of client modules 102, 105.

In some embodiments, server-side module 106 includes one or more processors 112, item tracking information 114, user account data 116, an I/O interface to one or more clients 118, and an I/O interface to one or more merchant servers 120. I/O interface to one or more clients 118 facilitates the client-facing input and output processing for server-side module 106. Processor(s) 112 are configured to: obtain requests for merchandise information initiated by shopper client device 105 or requests for customer interest information initiated by sales client device 107; in response to a merchandise information request, send requested merchandise information and establish tracking of merchandise for the requesting shopper, generating customer interest data for the requesting shopper and the merchandise; send identification data for the customer interest data to the shopper client device; in response to a customer interest information request (e.g., a request containing the identification data for the customer interest information), send the customer interest information to the requesting sales client device, and associating the sales clerk of the requesting sales client device with the customer and merchandise referred to in the requested customer interest information; process online shopping transaction for the shopper client device, and send update information and messaging from sales to customers regarding tracked merchandise. Item tracking information 114 stores merchandises, their respective identification codes, respective customers that are interested in the tracked merchandises, sales clerks that are associated with the tracked merchandises and customers. User account data 116 stores user accounts (e.g., shoppers' accounts and sales clerks' accounts) of the shopping platform/social networking platform. I/O interface to one or more merchant servers 120 facilitates communications with one or more merchant servers 122 (e.g., obtaining merchandise information for particular merchandises, receiving product updates for tracked merchandises, sales processing and payment processing for an item sold by the merchants, etc.).

Examples of client devices 104, 107 include, but are not limited to, a handheld computer, a wearable computing device, a personal digital assistant (PDA), a tablet computer, a laptop computer, a desktop computer, a cellular telephone, a smart phone, an enhanced general packet radio service (EGPRS) mobile phone, a media player, a navigation device, a game console, a television, a remote control, or a combination of any two or more of these data processing devices or other data processing devices.

Examples of one or more networks 110 include local area networks (LAN) and wide area networks (WAN) such as the Internet. One or more networks 110 are, optionally, implemented using any known network protocol, including various wired or wireless protocols, such as Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

Server system 108 is implemented on one or more standalone data processing apparatuses or a distributed network of computers. In some embodiments, server system 108 also employs various virtual devices and/or services of third party service providers (e.g., third-party cloud service providers) to provide the underlying computing resources and/or infrastructure resources of server system 108.

Server-client environment 100 shown in FIG. 1 includes both client-side portions (e.g., client-side modules 102, 105) and a server-side portion (e.g., server-side module 106). In some embodiments, data processing is implemented as a standalone application installed on client devices 104, 107. In addition, the division of functionalities between the client and server portions of client environment data processing can vary in different embodiments. For example, in some embodiments, client-side modules 102, 105 are thin-clients that provide only user-facing input and output processing functions, and delegate all other data processing functionalities to a backend server (e.g., server system 108). Sometimes, the client-side modules, such as generation of the identification data for customer interest in merchandise, obtaining of merchandise information, and storing merchandise information and customer interest data are performed on the client devices.

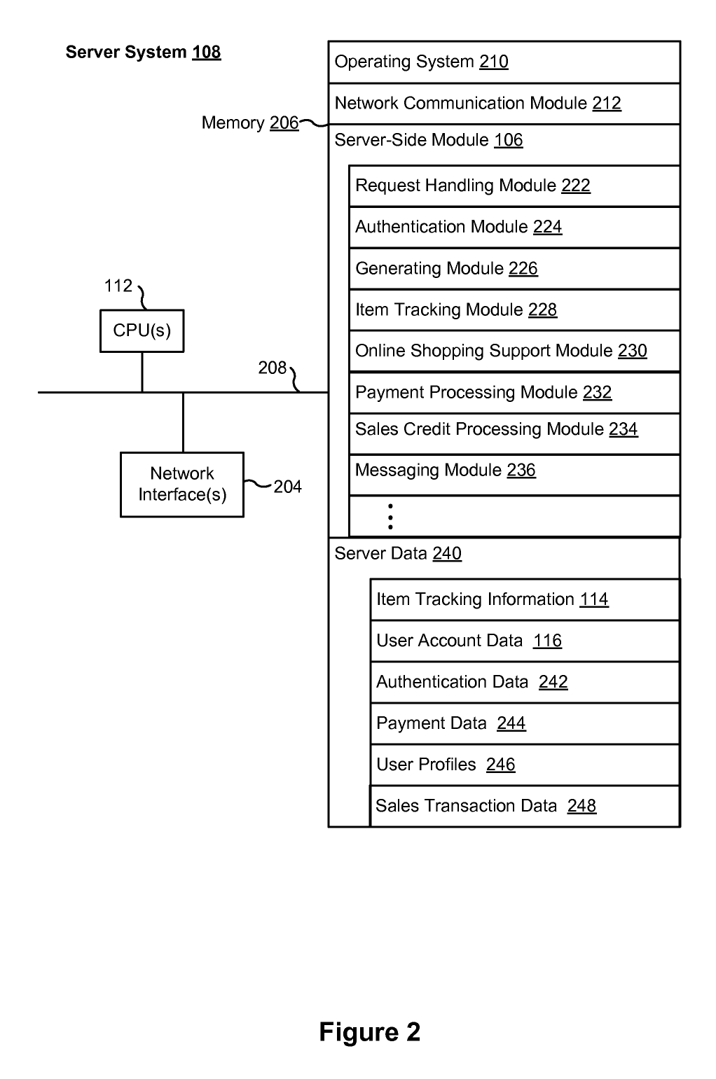

FIG. 2 is a block diagram illustrating server system 108 in accordance with some embodiments. Server system 108, typically, includes one or more processing units (CPUs) 112, one or more network interfaces 204 (e.g., including I/O interface to one or more clients 118 and I/O interface to one or more merchant servers 120), memory 206, and one or more communication buses 208 for interconnecting these components (sometimes called a chipset). Memory 206 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 206, optionally, includes one or more storage devices remotely located from one or more processing units 112. Memory 206, or alternatively the non-volatile memory within memory 206, includes a non-transitory computer readable storage medium. In some implementations, memory 206, or the non-transitory computer readable storage medium of memory 206, stores the following programs, modules, and data structures, or a subset or superset thereof:
operating system 210 including procedures for handling various basic system services and for performing hardware dependent tasks;
network communication module 212 for connecting server system 108 to other computing devices (e.g., client device 104 and browsing device 107, and merchant server(s) 122) connected to one or more networks 110 via one or more network interfaces 204 (wired or wireless);
server-side module 106, which provides server-side data processing for the shopping/social networking platform (e.g., instant messaging and other social networking services and/or payment processing), includes, but is not limited to:
   request handling module 222 for responding to requests for merchandise information and customer interest information initiated by client devices 105, 107 based on identification data (e.g., barcodes captured from physical merchandise, and from shopper's device);
   authentication module 224 for sending an authentication request to a shopper's client device 105 or a sales client device 107 and verifying received login credentials;
   generating module 226 for, responsive to a save request for merchandise information from a shopper, generating customer interest information associating the shopper with the merchandise, and generating corresponding identification data for the customer interest information;
   item tracking module 228 for, responsive to the request for merchandise information, establishing tracking of merchandise for each shopper that has requested the merchandise information and opted to save the merchandise information;
   online shopping support module 230 for, facilitating future browsing of saved merchandise by shoppers, sending updates on tracked items to shoppers who have saved the items, facilitating follow-up communications between sales clerks and shoppers regarding tracked merchandises, facilitating online purchase transactions for saved items;
   payment processing module 232 for processing the transaction based on the order information and payment information for the user stored in payment data 244; and
   sales credit processing module 234 for crediting the proper sales clerks for online sales that they have facilitated both online and offline; and
   messaging module 236 for managing and routing messages sent between users (shoppers and sales clerks) of the shopping/social networking platform; and
server data 240 storing data for the social networking platform, including but not limited to:
   item tracking information 114 storing merchandises, their respective identification codes, respective customers that are interested in the tracked merchandises, sales clerks that are associated with the tracked merchandises and customers;
   user account data 116 storing user accounts (e.g., shoppers' accounts and sales clerks' accounts) of the shopping platform/social networking platform;
   authentication data 242 storing login credentials for users (e.g., shoppers and sales clerks) of the shopping/social networking platform;
   payment data 244 storing payment information for users of the social networking platform (e.g., credit card information, store credit or gift card balance, billing address, shipping address, etc.);
   user profiles 246 storing user profiles for users of the social networking platform, where a respective user profile includes custom parameters (e.g., age, location, hobbies, etc.) for the user, social network contacts, groups of contacts to which the user belongs, and identified trends and/or likes/dislikes of the user;
   sales transaction data 248 storing actual sales made by shoppers through the shopping/social network platform, the sales transaction data 248 identifies the merchandise, shopper, sales clerk(s), quantity, time, etc. of the shopping transaction.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, memory 206, optionally, stores a subset of the modules and data structures identified above. Furthermore, memory 206, optionally, stores additional modules and data structures not described above.

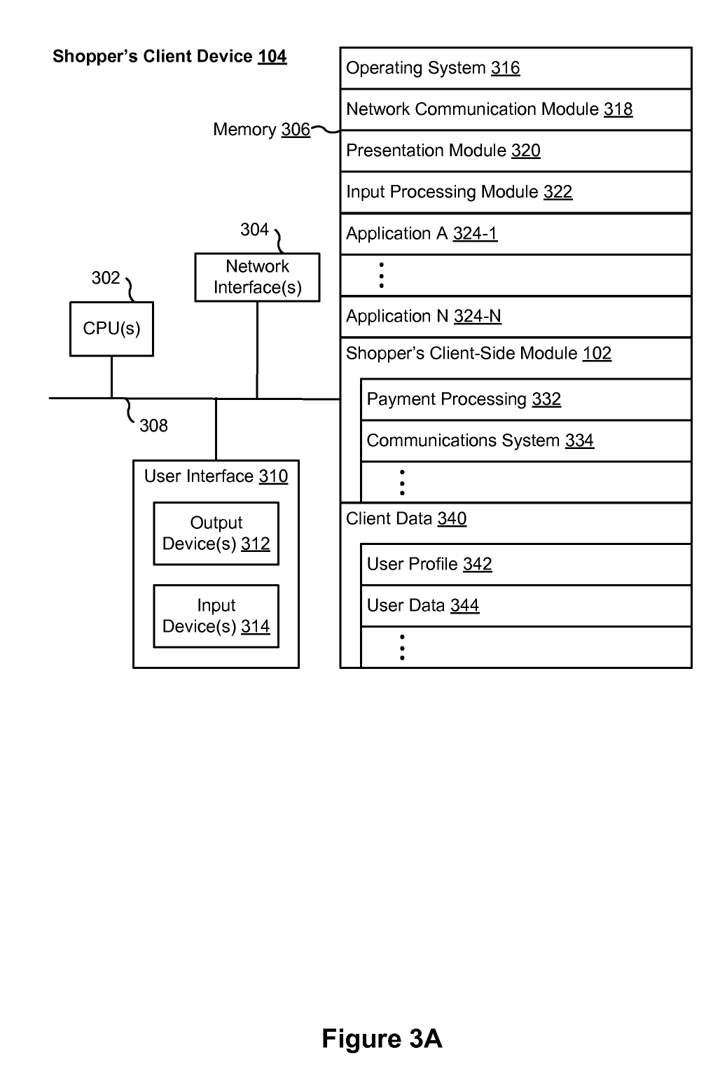

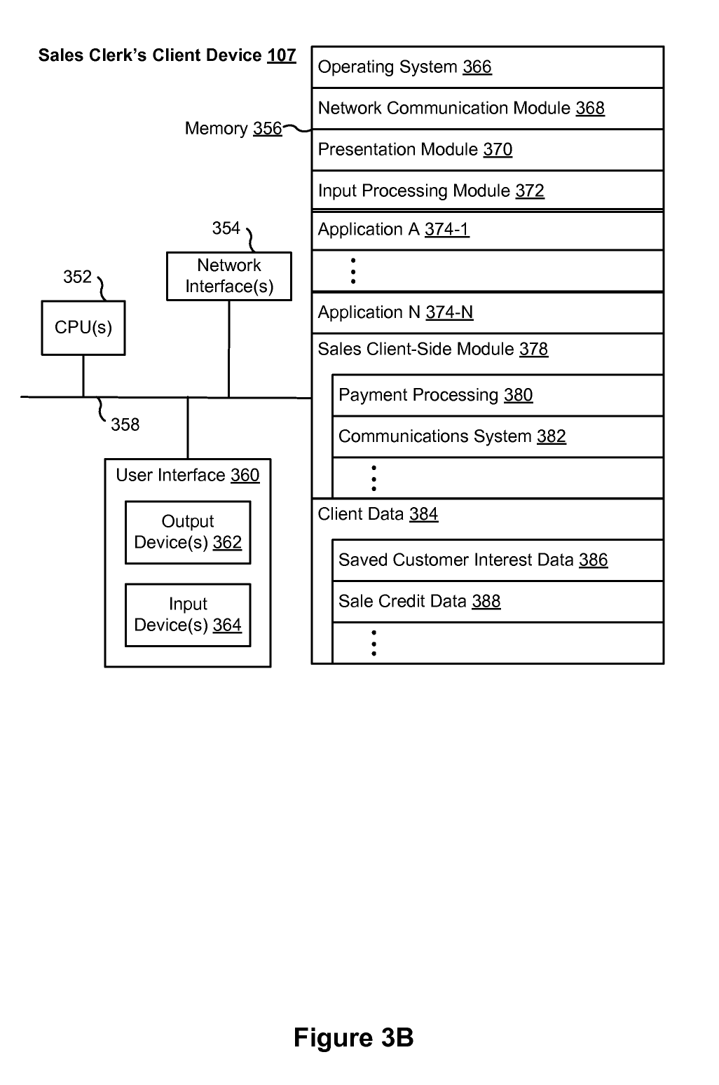

FIG. 3A is a block diagram illustrating a representative shopper's client device 104 associated with a user (e.g., a shopper) in accordance with some embodiments. Client device 104, typically, includes one or more processing units (CPUs) 302, one or more network interfaces 304, memory 306, and one or more communication buses 308 for interconnecting these components (sometimes called a chipset). Client device 104 also includes a user interface 310. User interface 310 includes one or more output devices 312 that enable presentation of media content, including one or more speakers and/or one or more visual displays. User interface 310 also includes one or more input devices 314, including user interface components that facilitate user input such as a keyboard, a mouse, a voice-command input unit or microphone, a touch screen display, a touch-sensitive input pad, a camera, a barcode or QR code scanner, a gesture capturing camera, or other input buttons or controls. Furthermore, some client devices 104 use a microphone and voice recognition or a camera and gesture recognition to supplement or replace the keyboard. Memory 306 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 306, optionally, includes one or more storage devices remotely located from one or more processing units 302. Memory 306, or alternatively the non-volatile memory within memory 306, includes a non-transitory computer readable storage medium. In some implementations, memory 306, or the non-transitory computer readable storage medium of memory 306, stores the following programs, modules, and data structures, or a subset or superset thereof:
operating system 316 including procedures for handling various basic system services and for performing hardware dependent tasks;
network communication module 318 for connecting client device 104 to other computing devices (e.g., server system 108 and merchant server(s) 122) connected to one or more networks 110 via one or more network interfaces 304 (wired or wireless);
presentation module 320 for enabling presentation of information (e.g., a user interface for a social networking platform, widget, webpage, game, and/or application, audio and/or video content, text, etc.) at client device 104 via one or more output devices 312 (e.g., displays, speakers, etc.) associated with user interface 310;
input processing module 322 for detecting one or more user inputs or interactions from one of the one or more input devices 314 and interpreting the detected input or interaction;
one or more applications 324-1-324-N for execution by client device 104; and
shopper's client-side module 102, which provides client-side data processing and functionalities for the shopping/social networking platform, including but not limited to:
   merchandise information acquisition 332 for acquiring identification information for a merchandise (e.g., by scanning a code arranged on the merchandise), acquiring merchandise information for the merchandise information from the server 108 by sending the identification information for the merchandise to the server 108;
   customer interest data acquisition 334 for receiving input for saving/tracking a merchandise, requesting the server 108 to track the merchandise and obtaining identification information for association between the shopper and the merchandise;
   payment processing 336 for processing payments associated with transactions initiated within the social networking platform or at a merchant's website based on a saved/tracked merchandise; and
   communication system 334 for sending and receiving messages (e.g., updates and/or discounts on saved merchandise) from other users (e.g., sales clerks or stores) of the social networking platform (e.g., via instant messaging, group chat, message board, message/news feed, and the like); and
   client data 340 storing data associated with the shopping/social networking platform, including, but is not limited to:
      user profile 342 storing a profile associated with the user of client device 104 including custom parameters (e.g., age, location, hobbies, etc.) for the user, social network contacts, groups of contacts to which the user belongs, and identified trends and/or likes/dislikes of the user; and
      user data 344 storing data authored, saved, liked, or chosen as favorites by the user of client device 104 in the shopping/social networking platform.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some implementations, memory 306, optionally, stores a subset of the modules and data structures identified above. Furthermore, memory 306, optionally, stores additional modules and data structures not described above.

FIG. 3B is a block diagram illustrating a representative sales client device 107 associated with a user in accordance with some embodiments. Sales client device 107, typically, includes one or more processing units (CPUs) 352, one or more network interfaces 354, memory 356, and one or more communication buses 358 for interconnecting these components (sometimes called a chipset). Sales client device 107 also includes a user interface 360. User interface 360 includes one or more output devices 362 that enable presentation of media content, including one or more speakers and/or one or more visual displays. User interface 360 also includes one or more input devices 364, including user interface components that facilitate user input such as a keyboard, a mouse, a voice-command input unit or microphone, a touch screen display, a touch-sensitive input pad, a gesture capturing camera, or other input buttons or controls. Furthermore, some sales client devices 107 use a microphone and voice recognition or a camera and gesture recognition to supplement or replace the keyboard. Memory 356 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 356, optionally, includes one or more storage devices remotely located from one or more processing units 352. Memory 356, or alternatively the non-volatile memory within memory 356, includes a non-transitory computer readable storage medium. In some implementations, memory 356, or the non-transitory computer readable storage medium of memory 356, stores the following programs, modules, and data structures, or a subset or superset thereof:
operating system 366 including procedures for handling various basic system services and for performing hardware dependent tasks;
network communication module 368 for connecting sales client device 107 to other computing devices (e.g., server system 108 and merchant server(s) 122) connected to one or more networks 110 via one or more network interfaces 354 (wired or wireless);
presentation module 370 for enabling presentation of information (e.g., a user interface for a social networking platform, widget, webpage, game, and/or application, audio and/or video content, text, etc.) at sales client device 107 via one or more output devices 362 (e.g., displays, speakers, etc.) associated with user interface 360;
input processing module 372 for detecting one or more user inputs or interactions from one of the one or more input devices 364 and interpreting the detected input or interaction;
one or more applications 374-1-374-N for execution by browsing device 107; and
sales client-side module 105, which provides client-side data processing and functionalities for the shopping/social networking platform, including but not limited to:
   customer interest information acquisition 380 for acquiring identification information for an association between a potential customer and a merchandise from a shopper (e.g., by scanning a code arranged on the shopper's client device), acquiring the customer interest information regarding the potential customer and the merchandise of interest from the server 108 by sending the identification information for the customer interest information to the server 108;
   communication system 382 for sending messages (e.g., updates and/or discounts on merchandise to interested shoppers), e.g., via instant messaging, group chat, message board, message/news feed, and the like; and
   client data 384 storing data associated with the shopping/social networking platform, including, but is not limited to:
      saved customer interest data 386 storing list of potential customers and respective list of merchandise that each potential customer has inquired about; and
      sales credit data 388 storing actual online sales or credit awarded to the sales clerk for the actual online sales that are made by each shopper that is tracked by the sales clerk for merchandise that is tracked by the shopper.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some implementations, memory 356, optionally, stores a subset of the modules and data structures identified above. Furthermore, memory 356, optionally, stores additional modules and data structures not described above.

In some embodiments, at least some of the functions of shopper's client device 104 can be performed by sales client device 107. In some embodiments, at least some of the functions of sales client device 107 are performed by shopper's client device 104. In some embodiments, a device can perform the role of the shopper's client device or the role of the sales client device depending on the operation mode chosen by its user. Sales client device 107 and shopper's client device 104 shown in FIGS. 3A-3B, respectively, are merely illustrative, and different configurations of the modules for implementing the functions described herein are possible in various embodiments.

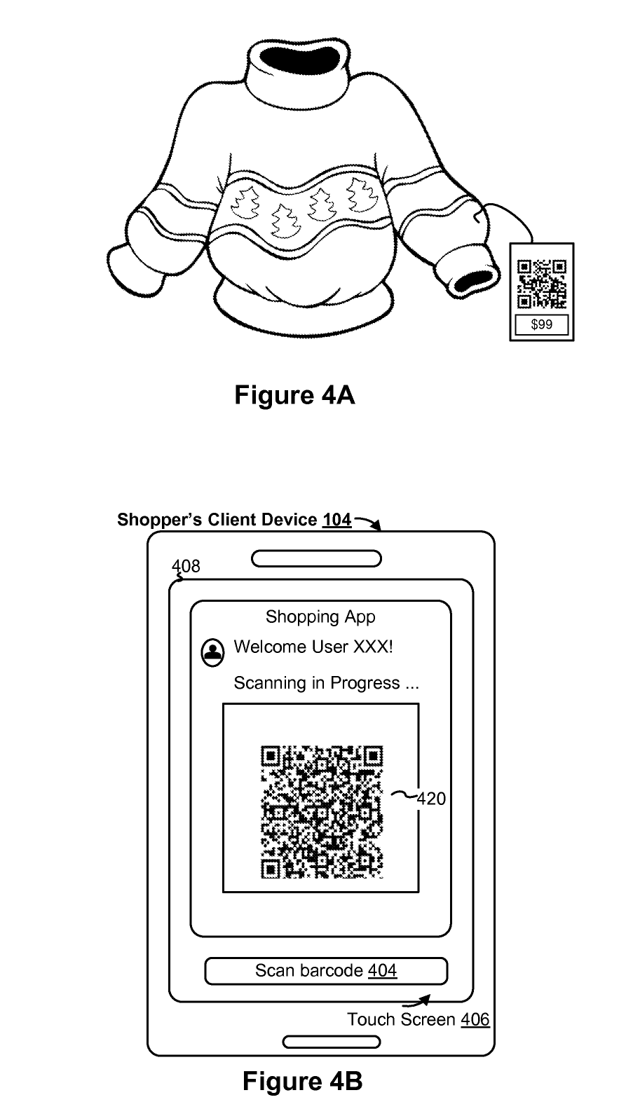

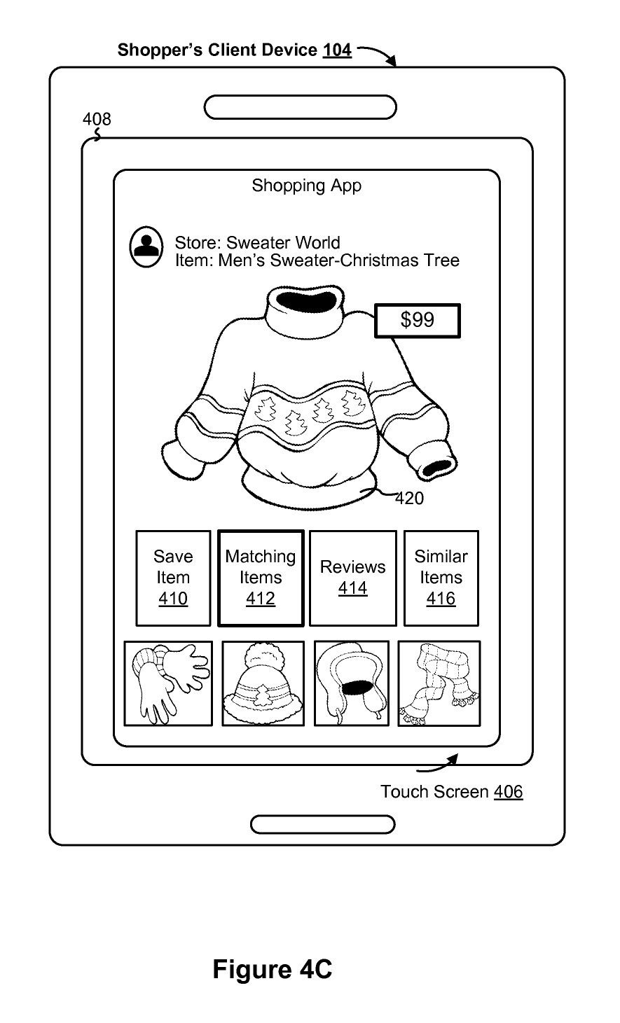

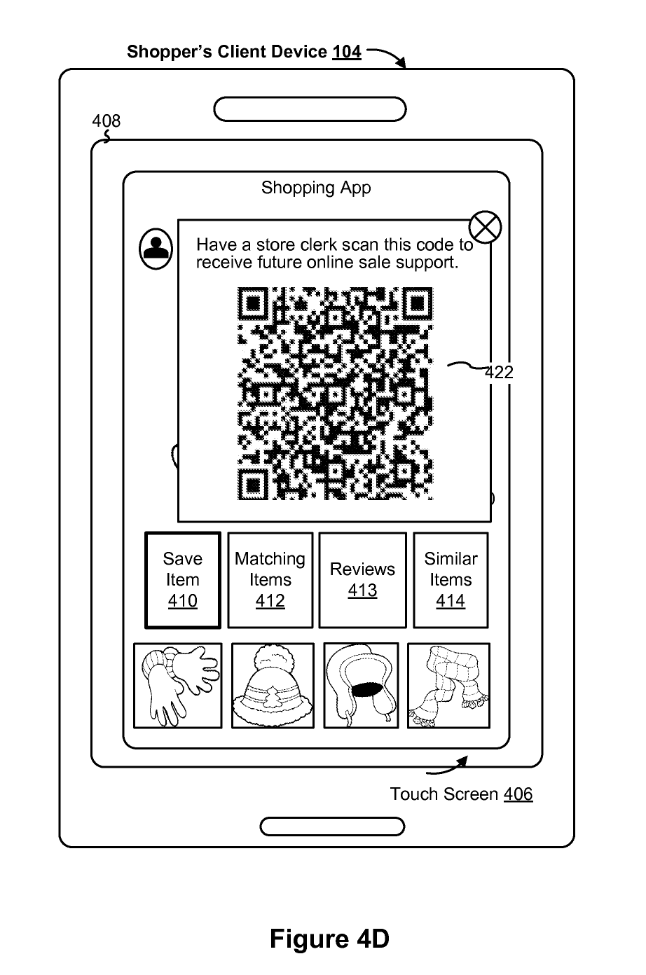

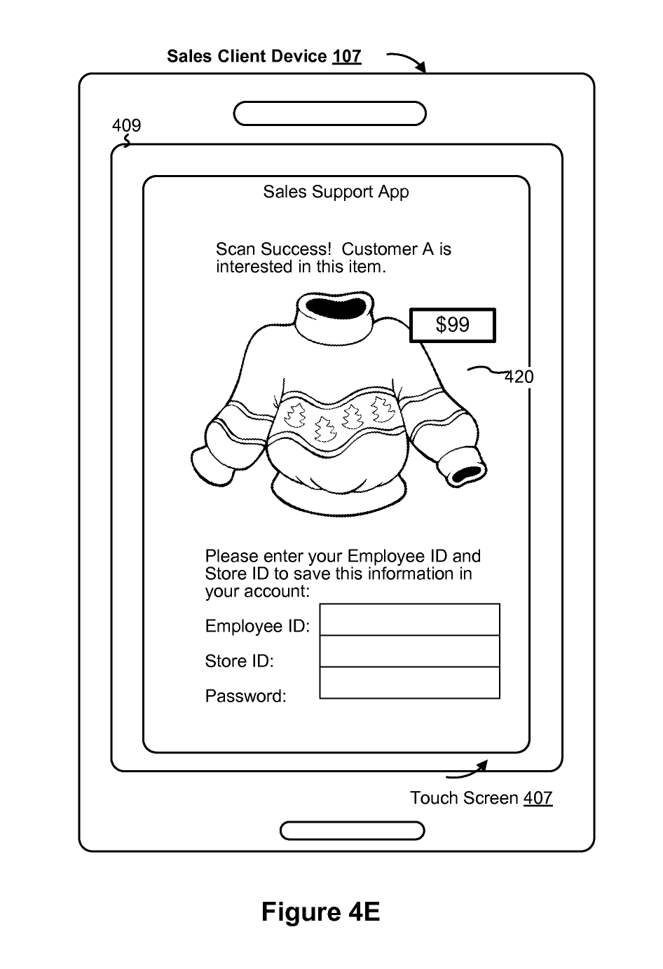

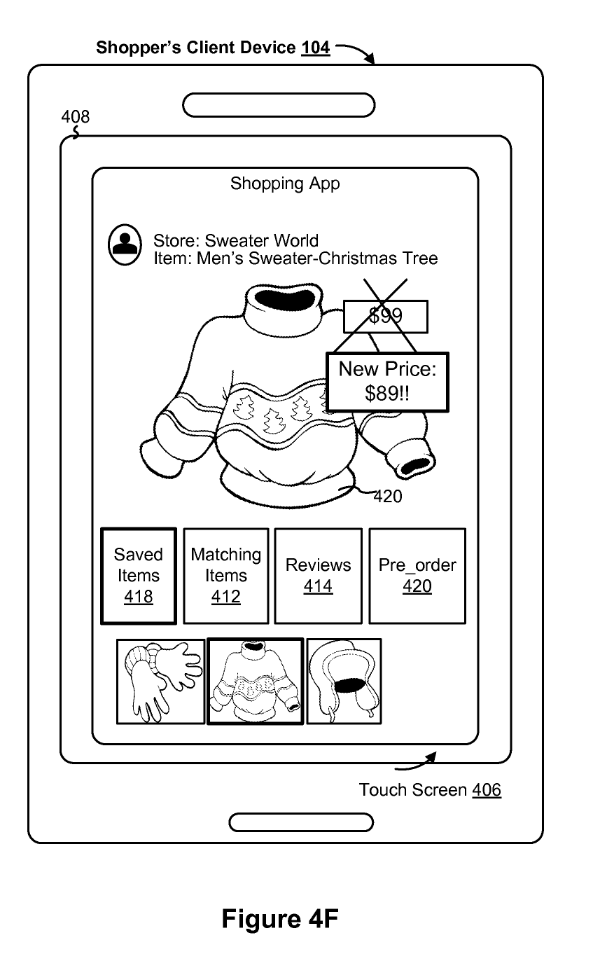

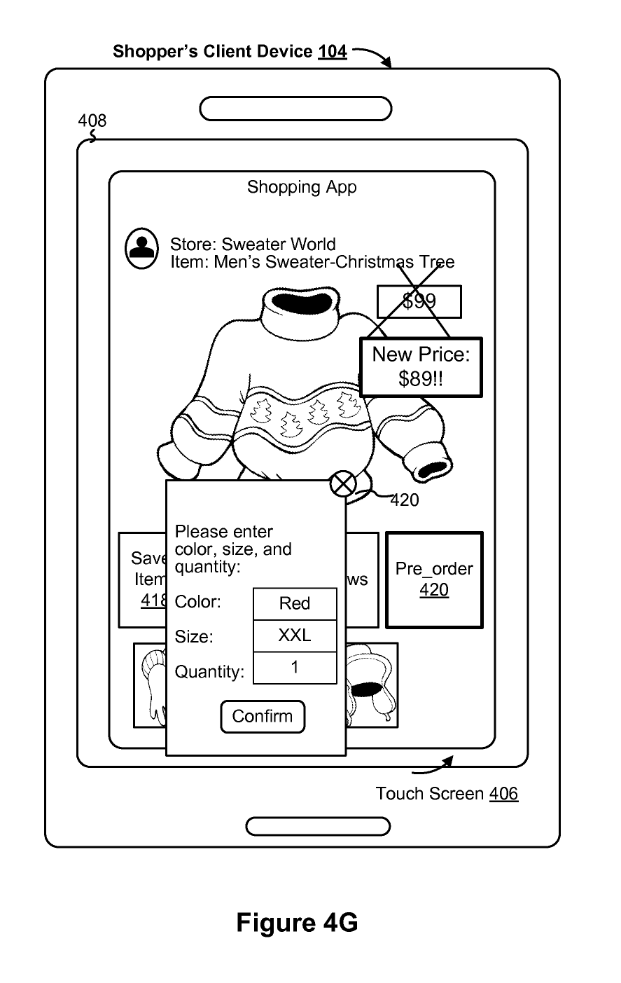

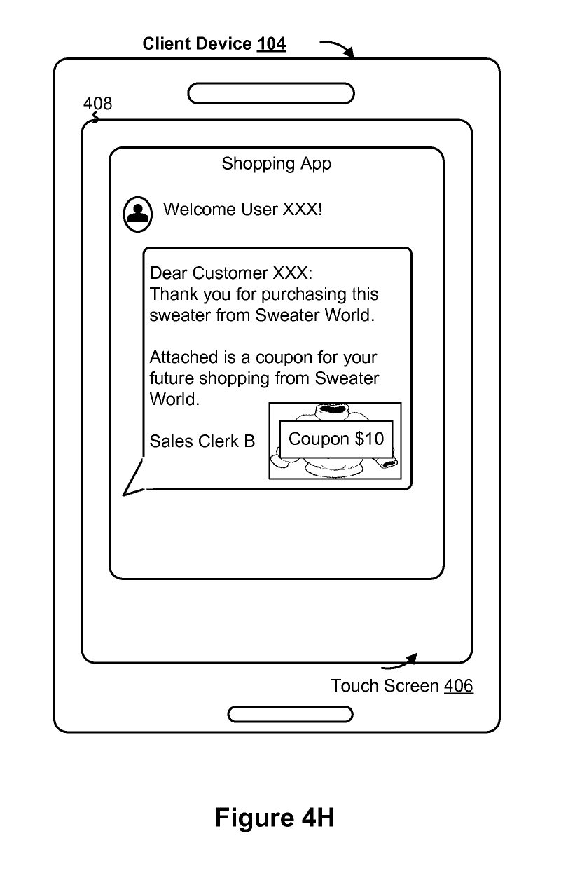

Attention is now directed towards embodiments of user interfaces and associated processes that may be implemented on a shopper's client device 104 with a touch screen 406 and a sales device 107 with a touch screen 407 (sometimes also herein called a touch screen displays) enabled to receive one or more user inputs (e.g., contacts on the touch screen) and display information (e.g., media content, webpages and/or user interfaces for a payment/transaction application). FIGS. 4A-4G illustrate exemplary user interfaces for establishing tracking of merchandise, and customer interest via a shopping/social networking platform in accordance with some embodiments.

Although some of the examples that follow will be given with reference to inputs on touch screens 406 and 407 (where the touch sensitive surface and the display are combined), in some embodiments, the device detects inputs on a touch-sensitive surface that is separate from the display. In some embodiments, the touch sensitive surface has a primary axis that corresponds to a primary axis on the display. In accordance with these embodiments, the device detects contacts with the touch-sensitive surface at locations that correspond to respective locations on the display. In this way, user inputs detected by the device on the touch-sensitive surface are used by the device to manipulate the user interface on the display of the device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse-based, stylus-based, or physical button-based input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact) or depression of a physical button. Similarly, when multiple user inputs are simultaneously detected, it should be understood that multiple computer mice are, optionally, used simultaneously, or a mouse and finger contacts are, optionally, used simultaneously.

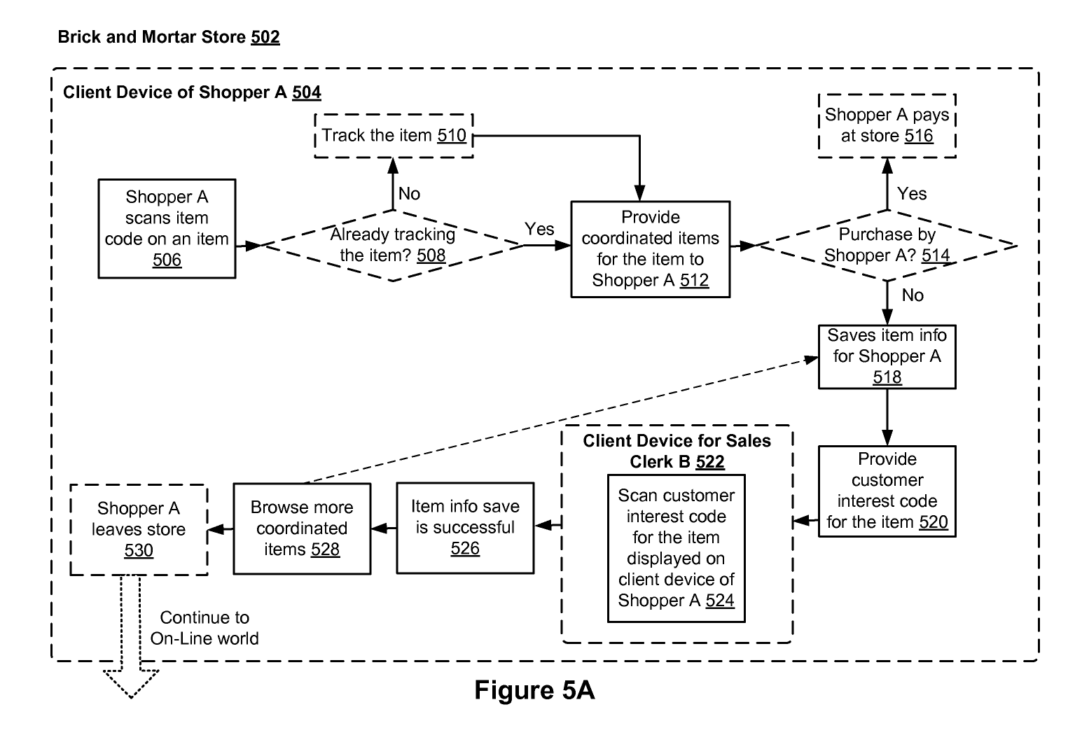

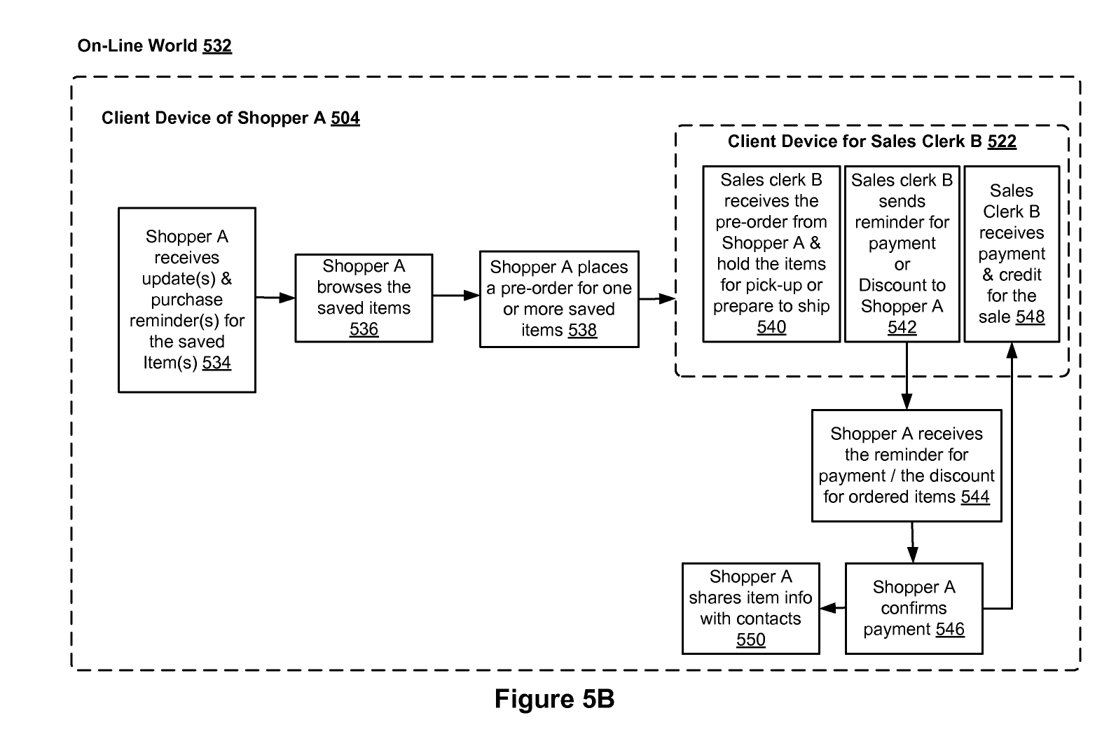

FIGS. 4A-4D and 4F-4H show interface 408 for a shopping user interface displayed on a shopper's client device 104 (e.g., a tablet, a mobile phone, or a laptop computer); however, one skilled in the art will appreciate that the user interfaces shown in FIGS. 4A-4D and 47-4H may be implemented on other similar computing devices. Figure E shows a sales clerk user interface 409 for a shopping/social networking platform/application displayed on a sales client device 107 (e.g., a tablet, a mobile phone, a POS device, or a laptop computer); however, one skilled in the art will appreciate that the user interfaces shown in FIG. 4E may be implemented on other similar computing devices. The user interfaces in FIGS. 4A-4H are used to illustrate the processes described herein, including the process described with respect to FIGS. 5A-5B, 6-8, and 9A-9C.

As shown in FIGS. 4A-4H, a first terminal (e.g., a shopper's client device 104) and a second terminal (e.g., a sales client device 107) may be mobile equipment commonly used by people, such as a smart phone or a PAD and the like. The first terminal or the second terminal may scan on a graphic bar code by a scanning module in an existing third-party IM (Instant Messaging) application, such as WeChat or QQ, and of course, the mode of acquiring identification information is not limited to the above. In the specific application scenes, the first terminal may be held by a shopper (e.g., a potential buyer of a merchandise on display), the second terminal may be held by a sales clerk (e.g., a seller of the merchandise), and accurate pushing of specific target merchandise information is implemented by establishing the relationship or association between the first terminal and the second terminal, i.e. the buyer and the seller, and the target merchandise information. Therefore, physical (i.e., offline) merchandise and online shopping can be connected, the buyer can more conveniently view the merchandise information and real object information when more diversified modes (e.g., online browsing of related products and reviews, etc.) are provided for shopping, and by the relationship and association between an employee of the seller (i.e., a sales clerk) with the second terminal and the potential buyer with the first terminal, the corresponding relationship (i.e., credit attribution) between the transaction data for the actual sale of the merchandise and the employee that contributed to the final successful sale of the merchandise can be conveniently obtained.

The specific implementing process of the present application is: the first terminal acquires first identification data (e.g., a product identifier or a 2D barcode for a merchandise) on a target merchandise (e.g., a sweater displayed in a store) and acquires the corresponding target merchandise information (e.g., name, price, reviews, coordinated products, similar products, etc.) by the first identification data (e.g., the product identifier or 2D barcode for the merchandise); the first terminal (and/or the user account that is currently active on the shopper's client device 104) is associated to the target merchandise (e.g., the sweater), and second identification data (e.g., a customer interest identifier or a unique 2D barcode for an association between a user and a merchandise that the user has shown an interest) is generated, wherein the second identification data comprises identification information of the first terminal (e.g., a user ID for the user account active on the shopper's client device 104) and the target merchandise information (e.g., the information on the sweater); the second terminal acquires the generated second identification (e.g., by scanning the newly obtained bar code for the customer interest that has been displayed on the first client terminal), and the first terminal, the second terminal and the target merchandise information are thus associated; and according to preset conditions, information related to the target merchandise (e.g., product updates) is pushed to the first terminal and/or the second terminal. The target merchandise information of the first identification data (e.g., the product identifier or 2D barcode for the merchandise) is acquired by the first terminal; the target merchandise information is associated to the identification information of the first terminal to generate the second identification data; information in the second identification data is acquired by the second terminal; association is established among the identification information of the first terminal; the identification information of the second terminal and the target merchandise information; and when the target merchandise in the first terminal or the second terminal has dynamic information (e.g., has an update), the dynamic information is respectively sent to the associated second terminal or first terminal, so that the pushed information obtained by the first terminal and the second terminal is more specific and accurate, which is more beneficial for improving accuracy of pushing the target merchandise information.

FIG. 4A to FIG. 4H illustrate example process and user interface for the pushing of merchandise information using a shopping mode of a social networking client application.

FIG. 4A shows a merchandise item (e.g., a sweater) on display in a brick and mortar shop. The sweater is provided with an identification data (e.g., in a two-dimensional code label, such as a 2D barcode printed on a physical tag attached to the sweater). Alternatively, the identification data can be printed on a sign or electronic display device associated with the merchandise item. For example, a sales clerk may show the two-dimensional code to a shipper to prompt the shopper to use his/her shopping/social networking client application to scan the code and acquire the target merchandise information for the item during shopping in the store.

In FIG. 4B, a first terminal (e.g., the shopper's client device 104) scans the two dimensional code label of the merchandise by using the scanning function in the shopping/social networking client application. As shown in FIG. 4B, the user of the first terminal has logged into his/her user account (e.g., user ID=XXX) on the shopping/social networking platform, and invoked the bar code scanning function using an affordance 404 to obtain the bar code 420 for the merchandise (e.g., the sweater). The tracking of the merchandise is optionally started for this user at this point. Target merchandise information for the tracked merchandise can be timely and conveniently pushed to the first terminal after association is established between the user's account and the tracked merchandise.

In FIG. 4C, by reading the identification data of the merchandise (e.g., the two-dimensional code of the merchandise), the first client terminal is granted access to merchandise information (e.g., store name, product name, matching items, reviews, similar items, etc.) related to the merchandise (e.g., the sweater) through the shopping/social networking client application. For example, the user interface 408 of the shopping/social network client application displays an image of the sweater, with its price and the name of the sweater and the name of the store selling the sweater. In addition, the user interface 408 also displays other user interface affordances to invoke other related shopping functions, such as a “save item” affordance 410 for saving the displayed merchandise (e.g., the sweater shown on user interface 408) and start tracking the merchandise, a “matching items” affordance 412 for obtaining other items in the store that will go with the displayed merchandise, a “reviews” affordance 414 for obtaining reviews of the displayed merchandise, a “similar items” 416 for obtaining similar items (e.g., other similar sweaters) for the displayed merchandise. For example, when the user invokes (e.g., by touching) the “matching items” affordance 412 (e.g., as indicated by the highlighted border of the “matching items” affordance 412), related matched articles (e.g., gloves, hats, scarf that are also sold in the store and that would coordinate well with the displayed sweater) are recommended to the user of the first terminal. For example, the matching items displayed in the first user terminal can also show comparisons between different colors of similar garments. By providing try-on effects on a model for the different combinations, the user can get more proper comparison of the overall look of the merchandise.

FIG. 4D shows the generation and display of second identification data (e.g., a customer interest identifier or a unique 2D barcode for an association between a user and the merchandise that the user has shown an interest) after acquiring a storage command for saving the merchandise information is received from the user. For example, when the user invokes the “save item” affordance 410, a two-dimensional code 422 is displayed on the first client terminal, the generated two-dimensional code includes the target merchandise information and identification information of the first terminal. The identification information of the first terminal is the user account ID that is currently active on the first terminal. In some embodiments, the second identification data is accompanied by a prompt for the shopper (i.e., the user of the shopper's client device 104) to ask a store clerk to scan the second identification data to establish an association between the sales clerk, the shopper, and the merchandise for subsequent online interactions regarding the sale or promotion of the merchandise. The shopper can also opt to close the second identification data without having any sales clerk obtain that information, so as to avoid subsequent contact of the sales clerk for the merchandise.

In FIG. 4E, a second terminal (e.g., the sales client device 107 held by a sales clerk in the store) scans the second identification data generated and/or displayed by the first terminal (e.g., the 2D barcode 422 shown in FIG. 4D). When the second terminal sends the second identification data to the server, the server associates the user account active on the second terminal with the merchandise and the user account active on the first terminal. In some embodiments, if all information is embedded in the 2D barcode already, the association can be done without the assistance of a server. In some embodiments, the association is performed by a server using the information obtained from the second terminal (e.g., the second identification data, and the user ID of the second terminal). When the user of the second client device (e.g., the sales clerk) carries out association for the first time, the user needs to first login as a sales clerk, e.g., input the employee number and store ID for the sales clerk (e.g., in the input fields shown in the user interface 409). To improve user experience and reduce the operation steps, the step in FIG. 4E also may be skipped and the target merchandise may be directly stored by the first terminal without being stored by the second terminal.

In FIG. 4F, the user of the shopper's client device 104 has left the store, and can still retrieve the save merchandise information through the shopping/social networking client application. For example, when the user invokes the “Saved Items” affordance 418 displayed in the user interface 408 after the user has left the store, a listing of saved merchandise items (e.g., including the sweater that was saved in FIG. 4D) can be displayed on the user interface 408. When the user selects each save merchandise item from the listing, the merchandise information of the selected merchandise item can be displayed in the user interface 408. In addition, in some embodiments, if any updates on the merchandise information become available for the selected merchandise item, the server would push the update information to the first client terminal, such that when the user reviews the merchandise information for the selected merchandise item, the updates will be displayed to the user as well. In this particular example, there is an update on the price of the merchandise (e.g., a price drop from $99 to $89), the update is pushed to the first client terminal by the server and displayed to the user. In some embodiments, the first client terminal can also proactively obtain the update information from the server from time to time. In addition, a “pre-order” affordance 420 for initiating a pre-ordering process or purchasing process for the selected merchandise item is also included in the user interface 408.

In FIG. 4G, the first terminal generates and/or displays dynamic information which is dynamic information of buying the target merchandise. For example, as shown in FIG. 4G, when the user of the shopper's client device 104 has invoked the “pre-order” affordance 420 when a saved merchandise item (e.g., the sweater) is displayed on the user interface 408, additional dynamic information (e.g., selection interface for inputting quantity, color, etc. for the pre-order) for making an online purchase is displayed in the user interface 408. In addition, in some embodiments, when the first terminal generates a purchase confirmation command, the dynamic information of the pre-order for the target merchandise (e.g., the sweater) using the first terminal is also sent to the second terminal according to the command. In some embodiments, the pre-order causes the sales clerk of the second terminal to hold the target merchandise for the shopper in the physical store for the shopper to pick up later, or prepares the target merchandise for shipping to the shopper. The server can facilitate the payment process online using the payment information stored for the shopper at the shopping/social networking platform. Sometimes, before the final confirmation of the user for the purchase, the sales clerk optionally sends messages to the shopper via the shopping/social networking platform with additional incentives (e.g., follow-ups, invitation for questions, additional discounts, etc.) to promote the sale of the merchandise.

FIG. 4H shows that the first terminal has received dynamic information generated by the second terminal, wherein the dynamic information may include an instant message containing arrival-of-goods information (e.g., an acknowledgement for the purchase of the sweater) or coming stock-out information of the target merchandise, and additional information for future sales (e.g., a coupon for future use by the shopper).

In some embodiments, by combining the terminals of the social networking platform and the two-dimensional code of the target merchandise, pushing of the target merchandise information may be conveniently implemented, so that accuracy of pushing the target merchandise information is improved and great convenience is brought to shopping of users.

FIGS. 5A-5B illustrate the process for the tracking of merchandise items by shoppers, and the tracking of customer and merchandise by sales clerks for promoting online sales based on offline shopping activities. The user interfaces shown in FIGS. 4A-4H can be displayed in various stages of the process shown in FIGS. 5A-5B.

As shown in FIG. 5A, the process that occurs in a brick-and-mortar store 502 includes the following. With respect to a client device 504 of the shopper (e.g., also referred to as the first terminal or the shopper's client device 104), the following actions occur during the physical shopping activity of the shopper A:

Shopper A browses the merchandise on display in the store 502, and scans (506) an item code (e.g., a 2D barcode) arranged on an item (e.g., a sweater). The 2D barcode encodes identification information for the item, and allows the client device 504 of the shopper to obtain the corresponding merchandise information of the item (e.g., either by decoding the identification information or by sending the identification information to a server). If the client device or the server determines that the user has already been tracking the item (e.g., by previous scan activities), the merchandise information corresponding to the item is provided to the client device 504 and displayed to shopper A. In some embodiments, the merchandise information includes information on coordinated items for the item. For example, matching accessories for a clothing item. In some embodiments, if the item is not yet tracked by the client device 504 or the server, the client device or server starts tracking (510) the item for the shopper AAA. The client device or server also provides (512) coordinated items for the item to shopper A to help the user make a proper selection for purchase. If the shopper A makes the purchase in the store (514), the shopper can pay (516) at the store in the normal fashion, e.g., by paying at the cashier of the store. If the shopper A does not want to make a purchase at the store at that time, the user can choose to save (518) the merchandise information for the item for later review and consideration. For example, the user can save the item in the shopping/social networking client application as shown in FIG. 4D. The user can retrieve the saved merchandise information online later.

When the shopper A has saved the merchandise information, customer interest information is generated by the client device 504 or the server, the client device or the server generates (520) customer interest code (e.g., identification code for the association between the shopper A and the saved merchandise information). The customer interest code can be displayed on the client device 504, as shown in FIG. 4D.

The client device of the sales clerk B can be used to scan (524) the customer interest code displayed on the client device 504. For example, if the sales clerk B has assisted the shopper A during shopper A's shopping in the store 502, the shopper A can ask the sales clerk B to scan the customer interest code for the saved merchandise, so that the sales clerk B can follow up with shopper A later to answer any questions, or follow up with additional information regarding the saved merchandise. In some embodiments, the shopper A can save multiple merchandise items seen in the store, and generate a single customer interest code for all of the merchandise he/she has shown an interest in (e.g., scanned the code on the merchandises using the client device 504) in the end before leaving the store. When the sales clerk scans the customer interest code, the client device 522 of the sales clerk B or the server can associate the sales clerk B with the shopper A and all of the merchandise from store 502 that the shopper A has saved in his/her shopping account.

When the user has successfully saved the merchandise information for an item, the server or the client device 504 provides a notification to the shopper A that the item information save is successful, and that the shopper A and retrieve this information later online.

The user can browse more coordinated items on the client device 504, and save one or more of the merchandise items discovered through the saved merchandise item using the shopping/social networking client application. For these additional items discovered online, the shopper A can also save the merchandise information, and generate customer interest code for the sales clerk B to scan. This way, the sales clerk B can also provide additional assistance online for the additional merchandise after the shopper A leaves the store 504.

When the shopper A leaves (530) the store, the shopper A can continue shopping of the merchandise of the store online using the shopping/social networking client application. As shown in FIG. 5B, when there is updates available for the merchandise items that have been saved by the shopper A, the server pushes such updates to the shopper A's client device 504. The server can also send reminders to the shopper A's client device regarding updates for the saved merchandise information. The shopper A can browse (536) the saved merchandise information and associated updates using the shopping/social networking client application. The shopper A can place a pre-order for one or more saved items using the shopping/social networking client application. When the shopper A places a pre-order, the pre-order is sent to the sales clerk associated with shopper A and the ordered item(s) or to the merchant server selling the item(s). In some embodiments, the sales clerk receives (540) the pre-order from the server, e.g., using the sale client device 522, and can hold the pre-ordered item(s) for shopper A to pick up at the store, or prepares the ship the item(s) to the shopper A. Sometimes, after receiving the pre-order from shopper A, the sales clerk B can also send (542) reminders or messages (e.g., instant messages) to shopper A via the shopping/social networking server to remind him about the payment. Sometimes, the sales clerk B can check his/her sales account to see the shoppers and items that have been associated with his/her sales account, and if any shopper has not make any pre-order after a certain period of time, the sales clerk B may offer a discount or follow-up with the shopper to promote the sale via one or more messages. When the shopper A receives (544) the reminder for payment or the offer of discounts from the sales clerk B, the shopper may proceed accordingly, e.g., to confirm payment or make an order. When the shopper A authorizes (546) payment, e.g., after receipt of the items or after confirming the order, the server coordinates (548) the payment transaction to transfer the required payment from the payment account of the shopper A to the account of the shop. In addition, the server also credits the sales clerk B for facilitating the successful sale of the order item(s) to shopper A. The sales clerk B will be able to see the sales credit being added (548) to his/her sales account for the actual sales made by the shopper-merchandise pairs associated with his/her sales account. In some embodiments, the shopper A can also share the saved items and/or purchased items and/or the contact information of sales clerks B with his/her social network contacts after the purchase. In some embodiments, the shopper A can forward the contact information of sales clerk B and/or merchandise information to a social network contact of shopper A, and sales clerk B will receive a notification from the server regarding the social network contact's interest in the merchandise information if the social network contact decides to save the merchandise information in his/her own account.

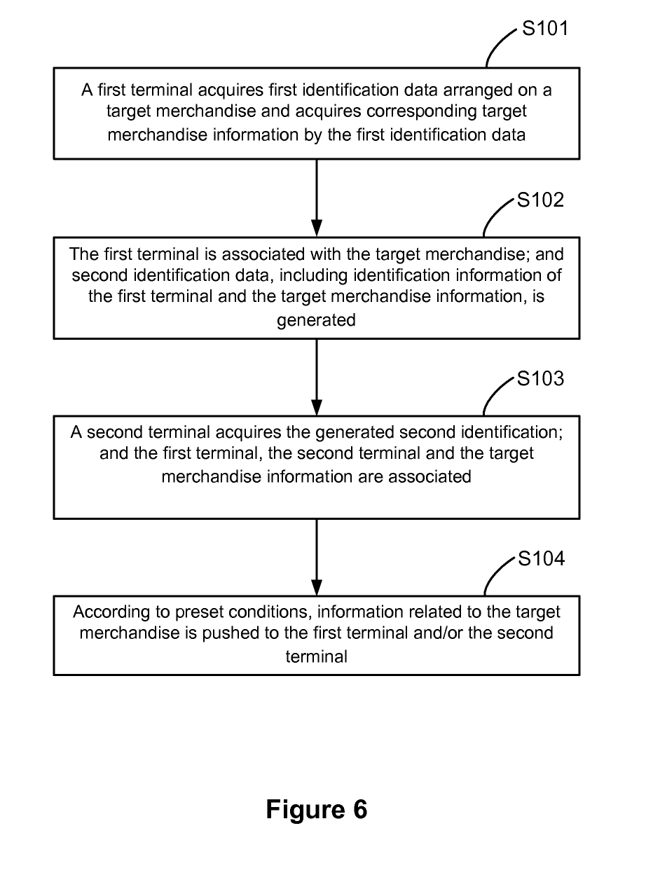

FIG. 6 shows the flow of merchandise information pushing method in accordance with some embodiments, which is detailed as follows.

In the step S101, the first terminal acquires the first identification data (e.g., the product identifier or 2D barcode for the merchandise) on the target merchandise and acquires the corresponding target merchandise information by the first identification data;

Specifically, the first terminal may be a smart phone held by a buyer, or also may be other equipment, such as a PAD and the like, which may carry out communication by the network and is convenient to carry.

The first identification data may be a bar code or a two-dimensional code which may include a URL for a webpage on the target merchandise or other related merchandise information and is used for accessing contents in a webpage page where the target merchandise is located by acquiring the URL after being connected with the network.

The first identification data is generally bound with the target merchandise in a label form, corresponding labels may be arranged for different types of target merchandise, the first identification data may be scanned in a physical store by a buyer (user) holding the first terminal, and when viewing the target merchandise that the user likes, the user scans the corresponding first identification on the target merchandise so as to conveniently record the target merchandise information by the first terminal.

In the step S102, the first terminal is associated to the target merchandise and the second identification data is generated, wherein the second identification data comprises the identification information of the first terminal and the target merchandise information;

The target merchandise information acquired by the first terminal may be a unique identification code of the target merchandise or the URL for the webpage of the target merchandise. The identification information of the first terminal may be account information of an IM application used by the first terminal, or also may be mobile phone number of the first terminal.

The first terminal may be associated to the target merchandise by receiving a “save” or “track/follow” command sent by the first terminal.

According to the unique identification code of the target merchandise or the page network address of the target merchandise and the identification information of the first terminal, the second identification data is generated. The second identification data may be a two-dimensional bar code, the corresponding second identification is generated according to encoding rules of a two-dimensional bar code graph, and similarly, the second identification data may be a two-dimensional code or a bar code and is displayed in a screen of the first terminal.

In the step S103, the second terminal scans the second identification data, and the identification information of the second terminal, which is obtained by scanning, the identification information of the first terminal and the target merchandise information are associated and stored.

The second terminal may be a smart phone held by a seller, or also may be other equipment, such as a PAD and the like, which can carry out communication by the network and is convenient to carry. By acquiring the second identification data on the screen of the first terminal through scanning and the like, the second terminal may acquire the target merchandise information and the identify identification information of the first terminal. Correspondingly, the target merchandise information may be the unique identification code of the target merchandise or the page IP address of the target merchandise and the like. The identification information of the first terminal may be the account information of the IM application used by the first terminal, or also may be the mobile phone number of the first terminal.

The identification information of the first terminal, the identification information of the second terminal and the target merchandise information are associated, and the associated information may be simultaneously stored into two terminals and also may be stored in a server.

In the step S104, according to the preset conditions, the information related to the target merchandise is pushed to the first terminal and/or the second terminal.

The associated information may be stored in at server. When the user uses the IM account to carry out association, the associated information also may be stored in the first terminal and the second terminal.

When the associated information is simultaneously stored in the two terminals, after the dynamic information of the target merchandise is monitored at the first terminal, the dynamic information is sent to the second terminal. Similarly, when the dynamic information of the target merchandise is monitored at the second terminal, the dynamic information is sent to the first terminal.

When the first terminal is the buyer, the dynamic information of the target merchandise, which is monitored by the first terminal, includes variation of status information for representing whether purchase is successful; when purchase is successful, the status information is automatically sent to the second terminal by associated data stored in the first terminal; and correspondingly, the second terminal is the seller or a shopping guide of the seller and can timely and effectively track the target merchandise and accurately push the corresponding target merchandise information to the first terminal.

The dynamic information of the target merchandise, i.e. the corresponding dynamic information of the target merchandise of the seller or the shopping guide of the seller, which includes price variation information of the target merchandise and information of inventory change (arrival of goods, stock-out and the like) of the target merchandise, is monitored; and the dynamic information is sent to the first terminal by means of the associated data stored in the second terminal, so that the first terminal timely and effectively acquires the information corresponding to the target merchandise.

When the associated information is simultaneously stored into the server, the operation is similar with that when the associated information is stored in the first terminal and the second terminal. The difference is that, after the dynamic information of the first terminal or the second terminal is monitored, the server sends the dynamic information to the corresponding terminal so as to implement accurate pushing of the target merchandise information.

Association among merchandise items, buyers and sellers is established at physical shops. When the merchandise items are browsed offline (e.g., in local stores), the merchandise items can be bought online, so that the shopping modes are more diversified. By online pushing of the dynamic information of the target merchandise between the buyer and the seller, interaction of merchandise shopping is improved. By means of information of physical merchandise provided in the physical shops, richer merchandise information can be acquired by the first identifications.

According to the first embodiment of the application, the target merchandise information of the first identification data is read by the first terminal, the target merchandise information is associated to the identification information of the first terminal to generate the second identification, the information in the second identification is directly read by the second terminal from the first terminal, association is established among the identification information of the first terminal, the identification information of the second terminal, and the target merchandise information. When the target merchandise in the first terminal or the second terminal has a dynamic information, the dynamic information is respectively sent to the associated second terminal or first terminal, so that the pushed information obtained between the first terminal and the second terminal is more specific and accurate, which is more beneficial for improving accuracy of pushing the target merchandise information.

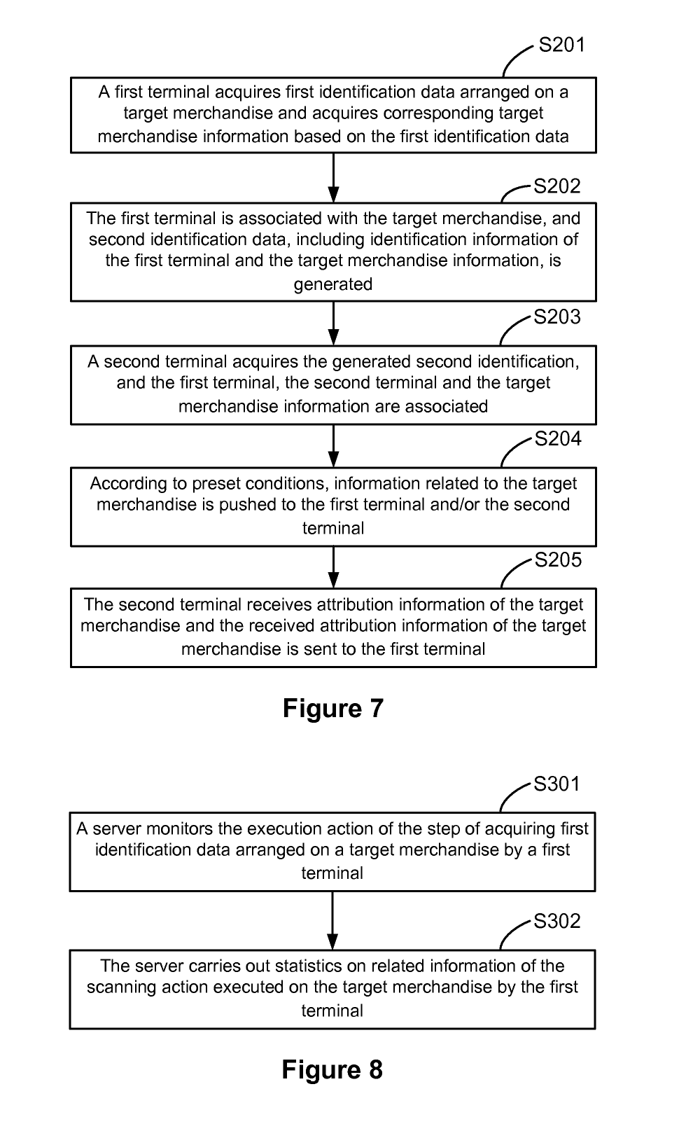

FIG. 7 shows the flow of a merchandise information pushing method in accordance with some embodiments, which is detailed as follows.

In the step S201, a first terminal acquires first identification on a target merchandise and acquires corresponding target merchandise information based on the first identification data, wherein the step that the first terminal acquires the first identification data on the target merchandise and acquires the corresponding target merchandise information based on the first identification data comprises:

A1, the first terminal acquires a page network address included in the first identification data on the target merchandise, wherein the page network address corresponds to the target merchandise. Because an existing two-dimensional code may include textual data, the first identification data may be one two-dimensional code and may include data of the page network address (e.g., URL).

A2, according to the page network address, the target merchandise information related to the target merchandise is acquired. The target commodities related to the target merchandise information also may include similar target commodities, or other target commodities matched with the target merchandise, such as trousers or shoes matched with scanned clothes in the class of clothing merchandise, a cutting board matched with a kitchen knife, a spatula matched with a pot and the like.

Certainly, that the first identification data is the two-dimensional code is only one of embodiments. In other some embodiments, the first identification data also may be a one-dimensional bar code including the unique identification sequence number information of the target merchandise, and the target merchandise information is acquired by the corresponding relation of a pre-stored serial number and the target merchandise.

To have an effective statistics on customer interest data of target merchandise so as to extract the information of tracked target merchandise, after the step S201, the step of carrying out statistics on the target merchandise data also may be executed and specifically comprises the steps S301 and S302 as shown in FIG. 8.

In the step S301, a server monitors the execution action of the step of acquiring the first identification data arranged on the target merchandise by the first terminal.

In the step S302, the server carries out statistics on related information of the scanning action executed on the target merchandise by the terminals, wherein the related information of the scanning action includes at least one of scanning time, scanning times and scanning frequency by a plurality of terminals.

When scanning the first identification data arranged on the target merchandise, the first terminal monitors the scanning action executed by the first terminal and sends the scanned target merchandise information to the server. Statistics is carried out according to the scanned target merchandise information sent by a plurality of different terminals so as to obtain times that the target merchandise information is scanned by a plurality of users, thereby carrying out effective and accurate statistics on popularity of the target merchandise in different time, and on the other hand, providing convenience for a seller to master trend information of the target merchandise.

In the step S202, the first terminal is associated to the target merchandise and second identification data (e.g., a customer interest identifier or a unique 2D barcode for an association between a user and a merchandise that the user has shown an interest) is generated, wherein the second identification comprises identification information of the first terminal and the target merchandise information.

In the step S203, a second terminal acquires the generated second identification, and the first terminal, the second terminal and the target merchandise information are associated.

In the step S204, according to preset conditions, information related to the target merchandise is pushed to the first terminal and/or the second terminal.

The step of pushing the information related to the target merchandise to the first terminal and/or the second terminal according to the preset conditions includes: the server monitors transaction status information of the target merchandise corresponding to the first identification data acquired in the first terminal. When the transaction status information of the target merchandise corresponding to the first identification data acquired in the first terminal is changed, the server sends the changed transaction status information to the second terminal. Alternatively, the server monitors status information of the target merchandise, which is received by the second terminal; and when the transaction status information of the target merchandise, which is received by the second terminal, is changed, the server sends the changed status information to the first terminal associated with the target merchandise.

In the step S205, the second terminal receives credit attribution information of the target merchandise and sends the received credit attribution information of the target merchandise to the first terminal.

The credit attribution information may comprise a shop name and address information of a shop which the target merchandise belongs to, or also may include information of shop assistants in the shop. When one shop assistant is associated to the second terminal at the first time, the information of the shop assistant needs to be input and sent to the system, so that in the subsequent operation, only the information of the shop assistant, which is stored in the second terminal, needs to be read.

The step S205 in the second embodiment aims to enable the first terminal to rapidly and effectively carry out physical purchasing according to the received credit attribution information of the target merchandise, and enable the shop to obtain the data of shopping guide, which corresponds to the second terminal, enrich the database with a large amount of the statistics data and improve accuracy of data statistics by receiving the attribution information of the target merchandise through second equipment.

Moreover, by the step S301 and the step S302, interest of the first terminal on the target merchandise information may be effectively subjected to statistics so as to improve accuracy of statistics of the system.

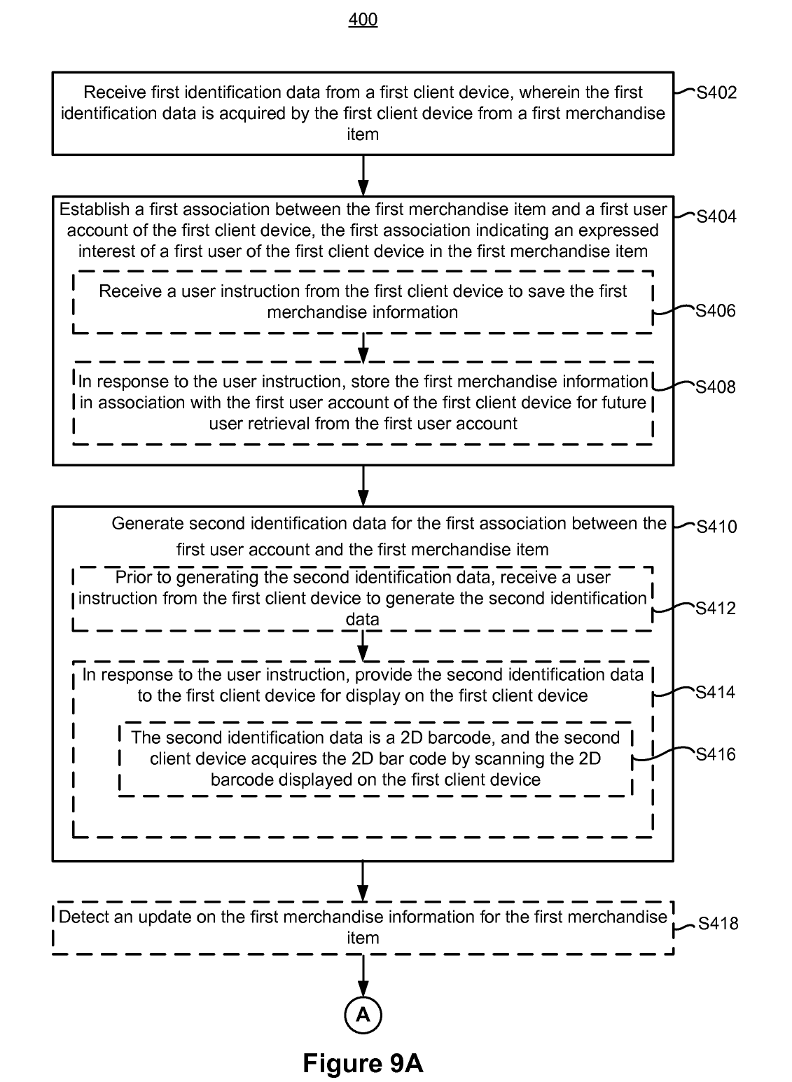

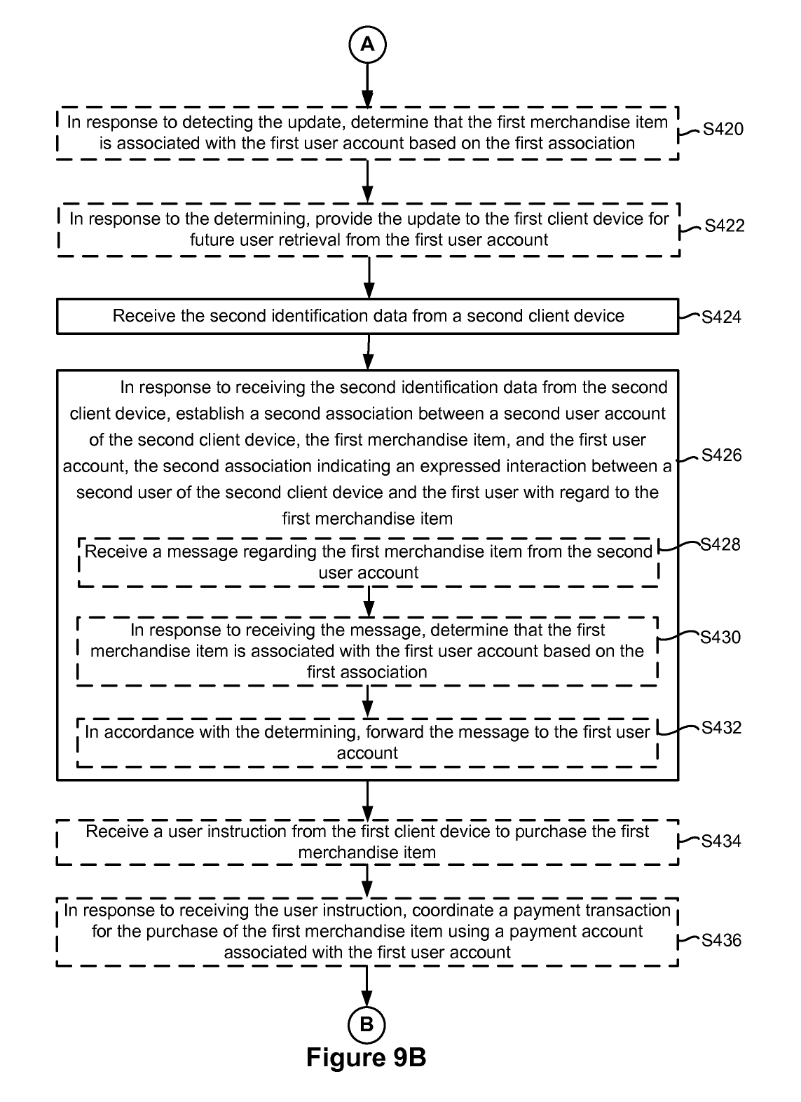

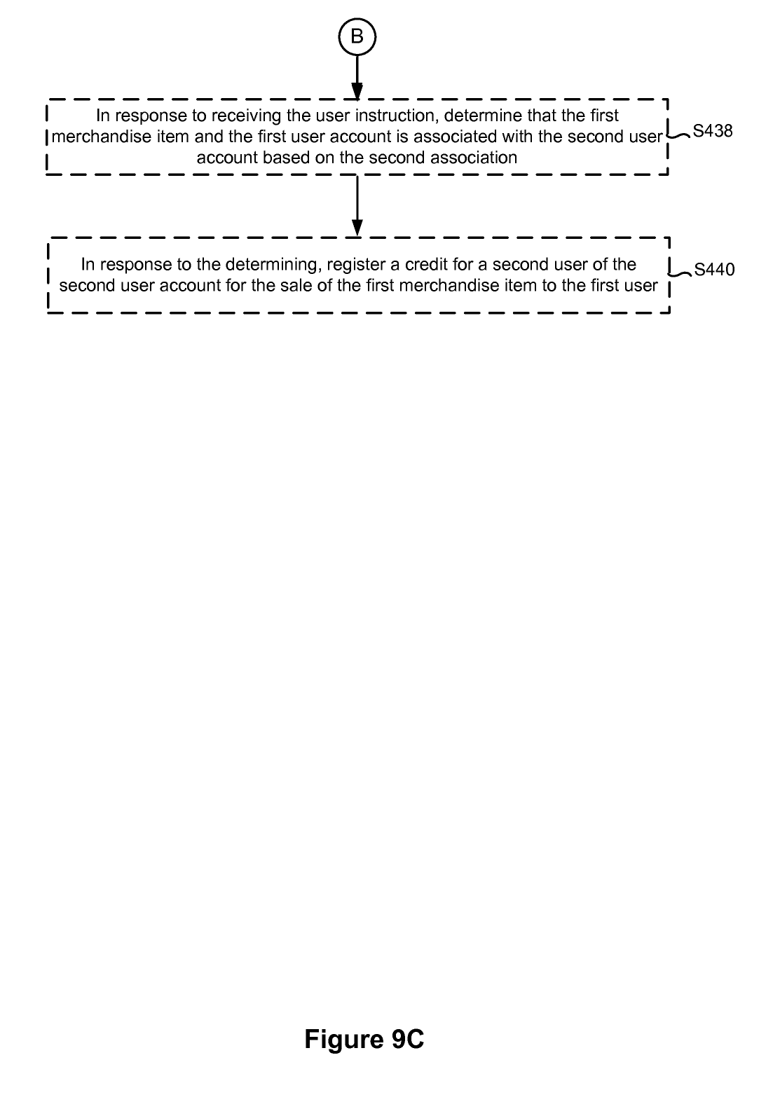

FIGS. 9A-9B illustrate a flowchart diagram of a method 400 of sharing order information via a social networking platform in accordance with some embodiments. In some embodiments, method 400 is performed by a server system 108 with one or more processors and memory. For example, in some embodiments, method 400 is performed by server system 108 (FIGS. 1-2) or a component thereof (e.g., server-side module 106, FIGS. 1-2). In some embodiments, method 400 is governed by instructions that are stored in a non-transitory computer readable storage medium and the instructions are executed by one or more processors of the server system. Optional operations are indicated by dashed lines (e.g., boxes with dashed-line borders).

In some embodiments, at a server having one or more processors and memory: the server receives (S402) first identification data from a first client device, wherein the first identification data is acquired by the first client device from a first merchandise item. The server establishes (S404) a first association between the first merchandise item and a first user account of the first client device, the first association indicating an expressed interest of a first user of the first client device in the first merchandise item. In some embodiments, the first identification data is a 2D barcode scanned by the first client device from the first merchandise. In some embodiments, in response to receiving the first identification data from the first client device, the server provides first merchandise information corresponding to the first merchandise item to the first client device.

In some embodiments, establishing the first association between the first merchandise item and the first account of the first client device further includes: receiving (S406) a user instruction from the first client device to save the first merchandise information; and in response to the user instruction, storing (S408) the first merchandise information in association with the first user account of the first client device for future user retrieval from the first user account.

In some embodiments, the server generates (S410) second identification data for the first association between the first user account and the first merchandise item.

In some embodiments, prior to generating the second identification data, the server receives (S412) a user instruction from the first client device to generate the second identification data. In response to the user instruction, the server provides (S414) the second identification data to the first client device for display on the first client device. In some embodiments, the second identification data is (S416) a 2D barcode, and the second client device acquires the 2D bar code by scanning the 2D barcode displayed on the first client device.

In some embodiments, the server detects (S418) an update on the first merchandise information for the first merchandise item. In response to detecting the update, the server determines (S420) that the first merchandise item is associated with the first user account based on the first association. In response to the determining, the server provides (S422) the update to the first client device for future user retrieval from the first user account.

In some embodiments, the server receives (S424) the second identification data from a second client device. In response to receiving the second identification data from the second client device, the server establishes (S426) a second association between a second user account of the second client device, the first merchandise item, and the first user account, where the second association indicates an expressed interaction between a second user of the second client device and the first user with regard to the first merchandise item.

In some embodiments, the server receives (S428) a message regarding the first merchandise item from the second user account. In response to receiving the message, the server determines (S430) that the first merchandise item is associated with the first user account based on the first association. In accordance with the determining, the server forwards (S432) the message to the first user account.

In some embodiments, the server receives (S434) a user instruction from the first client device to purchase the first merchandise item. In response to receiving the user instruction, the server coordinates (S436) a payment transaction for the purchase of the first merchandise item using a payment account associated with the first user account. In some embodiments, in response to receiving the user instruction, the server determines (S438) that the first merchandise item and the first user account is associated with the second user account based on the second association. In response to the determining, the server registers a credit for a second user of the second user account for the sale of the first merchandise item to the first user.

Other details of the process are disclosed with respect to FIGS. 1-8 and are not repeated in the interest of brevity.

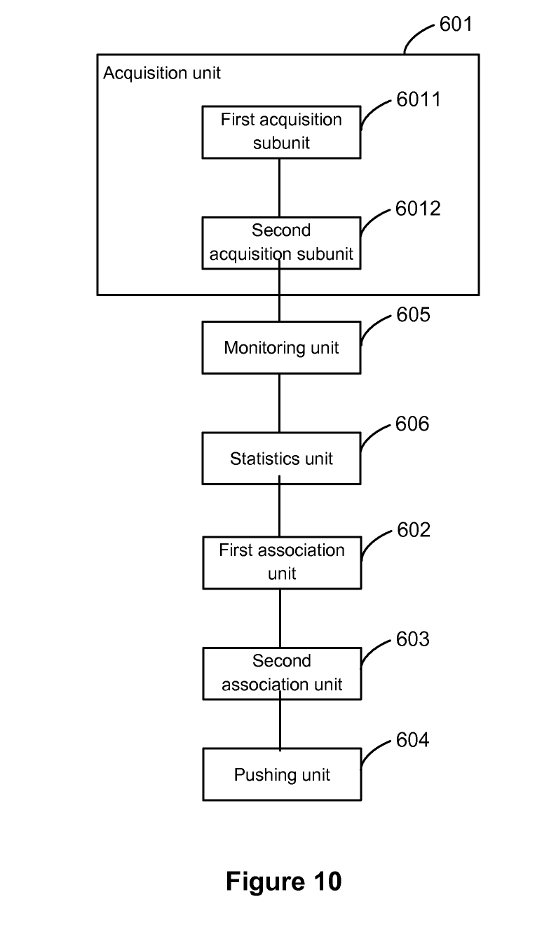

FIG. 10 shows a structural diagram of a merchandise information pushing apparatus according to the fourth embodiment of the application, which is detailed as follows.

The merchandise information pushing apparatus according to the fourth embodiment of the application comprises:

An acquisition unit 601 for acquiring first identification data (e.g., a product identifier or a 2D barcode for a merchandise) arranged on a target merchandise by a first terminal and acquiring corresponding target merchandise information with the first identification data;

A first association unit 602 for associating the first terminal with the target merchandise and generating second identification data (e.g., a customer interest identifier or a unique 2D barcode for an association between a user and a merchandise that the user has shown an interest), wherein the second identification comprises identification information of the first terminal and the target merchandise information;

A second association unit 603 for acquiring the generated second identification by a second terminal and associating the first terminal, the second terminal and the target merchandise information; and

A pushing unit 604 for pushing information related to the target merchandise to the first terminal and/or the second terminal according to preset conditions.

Optionally, the acquisition unit 601 comprises:

A first acquisition subunit 6011 for enabling the first terminal to acquire a page IP address included in the first identification data on the target merchandise, wherein the page IP address corresponds to the target merchandise;

A second acquisition subunit 6012 for acquiring the target merchandise information related to the target merchandise according to the page network address.

To further improve accuracy and integrity of data acquired by the apparatus, the apparatus further includes:

A monitoring 605 for enabling a server to monitor the execution action of the step of acquiring the first identification data arranged on the target merchandise by the first terminal; and

A statistics unit 606 for enabling the server to carry out statistics on related information of the scanning action executed on the target merchandise by the terminal, wherein the related information of the scanning action includes at least one of scanning time, scanning times and scanning frequency.

In some embodiments, the identification information of the first terminal or the second terminal is the account information of an IM application.

The apparatus in FIG. 10 corresponds to the methods described with respect to FIGS. 1-9C, and more details are not repeatedly described in the interest of brevity.

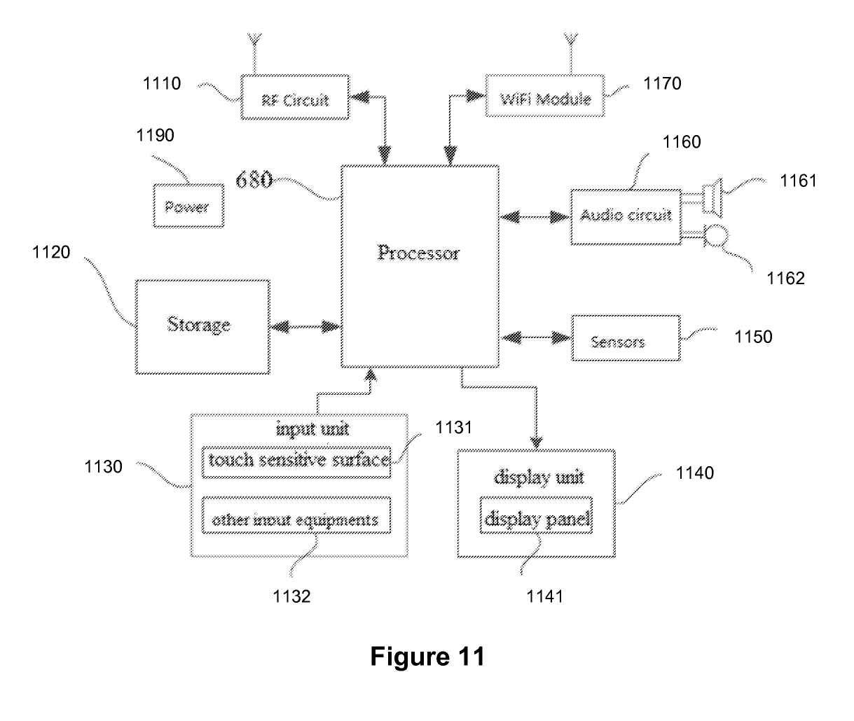

FIG. 11 shows a block diagram of a part of structure of a mobile phone related to a terminal according to the fifth embodiment of the application. With reference to FIG. 11, the mobile phone includes: an RF (Radio Frequency) circuit 1110, a storage 1120, an input unit 1130, a display unit 1140, a sensor 1150, an audio circuit 1160, a WiFi (Wireless Fidelity) module 1170, a processor 1180, a power supply 1190 and the like. Those skilled in the art can understand that the mobile phone is not limited to the structure shown in FIG. 11, and may include more or fewer parts than those in FIG. 11, or some parts may be combined, or different arrangement of parts may be adopted.

By combining FIG. 11, each part of the mobile phone is introduced in details as follows.

The RF circuit 1110 may be used for receiving and sending a signal during transceiving information or calling, particularly may be used for sending downlink information of a base station to the processor 1180 for process after receiving the downlink information and additionally may be used for sending uplink data to the base station. Generally, the RF circuit includes, but not limited to, an antenna, at least one amplifier, a transceiver, a coupler, an LNA (Low Noise Amplifier), a duplexer and the like. Furthermore, the RF circuit 1110 also may be communicated with other equipment by wireless communication and/or the network. The wireless communication may be used with any one of communication standards or protocols which include, but not limited to, GSM (Global System of Mobile Communication), a GPRS (General Packet Radio Service), CDMA (Code Division Multiple Access), WCDMA (Wideband Code Division Multiple Access), LTE (Long Term Evolution), E-mail, an SMS (Short Messaging Service) and the like.

The storage 1120 may be used for storing software programs and software modules. The processor 1180 executes various functional applications and data processing by operating the software programs and the software modules, which are stored in the storage 1120. The storage 1120 may mainly comprise a program storage region and a data storage region, wherein the program storage region may be used for storing operating systems, applications required by at least one function (such as a sound play function, an image play function etc.,) and the like; and the data storage region may be used for storing data (such as audio data, a telephone book etc.,) and the like which are created according to use of the mobile phone. Furthermore, the storage 1120 may include a high speed RAM (Random Access Memory) and also may include a non-volatile memory and at least one disk storage device, a flash memory device or other volatile solid storage devices.

The input unit 1130 may be used for receiving input number or character information and generating key signal inputs related to user's setting and functional control of the mobile phone 1100. Particularly, the input unit 1130 may comprise a touch control panel 1131 and other input equipment 1132. The touch control panel 1131 is also named a touch screen and may be used for detecting touch operations (for example, operations carried out by the user through using any suitable objects or attachments, such as a finger, a touch pen and the like, on the touch control panel 1131 or near the touch control panel 1131) of a user on the touch control panel or near the touch control panel and driving corresponding apparatus connected therewith according to a preset program. Optionally, the touch control panel 1131 may include a touch detection apparatus and a touch controller. The touch detection apparatus is used for detecting the touch direction of the user, detecting a signal caused by the touch operation and transmitting the signal to the touch controller. The touch controller is used for receiving touch information from the touch detection apparatus, converting the touch information into contact coordinates and then sending the contact coordinates to the processor 1180 and may receive a command sent by the processor 1180 and execute the command. Moreover, the touch control panel 1131 may be implemented by adopting various types such as a resistance type, a capacitance type, an infrared type, a surface acoustic wave type and the like. Except the touch control panel 1131, the input unit 1130 also may include other input equipment 1132. Particularly, other input equipment 1132 may include, but not limited to, one or more of physical keyboard, virtual (function) keys (such as a volume control key, a switching key and the like), trackball, mouse, operating rod and the like.

The display unit 1140 may be used for displaying information input by the user or information provided for the user and various menus of the mobile phone. The display unit 1140 may include a display panel 1141. Optionally, the display panel 1141 may be configured in forms of an LCD (Liquid Crystal Display), an OLED (Organic Light-Emitting Diode) and the like. Furthermore, the touch control panel 1131 may cover the display panel 1141. When the touch control panel 1131 detects the touch operation on the touch control panel 1131 or near the touch control panel 1131, the signal caused by the touch operation is transmitted to the processor 1180 to determine the type of a touch event. Then the processor 1180 provides a corresponding visual output on the display panel 1141 according to the type of the touch event. In FIG. 11, the touch control panel 1131 and the display panel 1141 are used as two independent parts for implementing input and output functions of the mobile phone, however, in a certain embodiments, the touch control panel 1131 and the display panel 1141 may be integrated to implement the input and output functions of the mobile phone.

The mobile phone 1100 also may include at least one sensor 1150, such as an optical sensor, a motion sensor and other sensors. Particularly, the optical sensors may include an environmental light sensor and a proximity sensor, wherein the environmental light sensor may regulate brightness of the display panel 1141 according to the light and lightness of environmental light. The proximity sensor may shut down the display panel 1141 and/or backlight when the mobile phone is moved to the position near an ear. As one of the motion sensors, an accelerometer sensor may detect the value of an acceleration in each direction (generally, three directions or three axes), may detect the value and the direction of gravity in a static state, which may be used posture identifying functions (such as switching between a horizontal screen and a vertical screen, switching related to a game, and calibration on the posture of a magnetometer), vibration identifying functions (such as for pedometer and striking) and the like, in the touch screen terminal. Furthermore, a gyroscope, a barometer, a humidity meter, a thermometer, an infrared sensor and other sensors may be integrated into the touch screen terminal 1100, to which explanation are not repeated herein

The audio circuit 1160, a speaker 1161 and a microphone 1162 can provide audio interfaces between the user and the mobile phone. The audio circuit 1160 may transmit an electric signal obtained by converting received audio data the speaker 1161 and the electric signal is converted into a sound signal to be output by the speaker 1161. On the other hand, the microphone 1162 converts a collected sound signal into an electric signal, the audio circuit 1160 receives the electric signal and converts the electric signal into audio data. After the audio data is output to the processor 1180 and is processed, the audio data is sent to another mobile phone through the RF circuit 1110, or the audio data is output to the storage 1120 in order to be further processed.

WiFi belongs to the technology of short distance wireless transmission. The mobile phone can help the user to receive and send emails, browse webpages, access streaming media and the like by the WiFi module 1170. The WiFi module 1170 provides wireless broadband internet access for the user. Although the WiFi module 1170 is shown in FIG. 11, it should be understood that the WiFi module 1170 is not the necessary composition of the mobile phone 1100 and completely may be omitted as not required without changed of the scope of the application.

The processor 1180 is a control center of the mobile phone, is connected with all the parts of the whole mobile phone by various interfaces and lines and is used for executing various functions of the mobile phone and processing the data by operating or executing the software programs and/or the software modules, which are stored in the storage 1120, and calling the data stored in the storage 1120 so as to carry out integral monitoring on the mobile phone. Optionally, the processor 1180 may include one or more processing units. Preferably, the processor 1180 may be integrated with an application processor and a modulation-demodulation processor, wherein the application processor is mainly used for an operating system, a user interface, applications and the like, and the modulation-demodulation processor is mainly used for wireless communication. It should be understood that the modulation-demodulation processor also may be not integrated into the processor 1180.

The mobile phone also includes the power supply 1190 (such as a battery) for supplying power to each part. Preferably, the power supply may be logically connected with the processor 1180 by a power supply management system so as to implement functions of charge management, discharge management, power consumption management and the like by the power supply management system.

The touch screen terminal 1100 also may include a camera, a Bluetooth module and the like although they are not shown in the figure, and explanations for them are not repeated herein.

In some embodiments, the processor 1180 included in each terminal also has the function of executing the merchandise information pushing method including the following steps:

The first terminal acquires the first identification data arranged on the target merchandise and acquires the corresponding target merchandise information by the first identification data;

The first terminal is associated with the target merchandise and the second identification is generated, wherein the second identification comprises the identification information of the first terminal and the target merchandise information;

The second terminal acquires the generated second identification, and the first terminal, the second terminal and the target merchandise information are associated; and

According to the preset conditions, the information related to the target merchandise is pushed to the first terminal and/or the second terminal.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain principles of the invention and its practical applications, to thereby enable others skilled in the art to best utilize the invention and various implementations with various modifications as are suited to the particular use contemplated. Implementations include alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

What is claimed is:

1. A method of pushing merchandise information, comprising:
at a server having one or more processors and memory:
receiving first identification data from a first client device, wherein the first identification data is acquired by the first client device from a first merchandise item;
establishing a first association between the first merchandise item and a first user account of the first client device, the first association indicating an expressed interest of a first user of the first client device in the first merchandise item;
generating second identification data for the first association between the first user account and the first merchandise item;
receiving the second identification data from a second client device; and
in response to receiving the second identification data from the second client device, establishing a second association between a second user account of the second client device, the first merchandise item, and the first user account, the second association indicating an expressed interaction between a second user of the second client device and the first user with regard to the first merchandise item.

2. The method of claim 1, wherein the first identification data is a 2D barcode scanned by the first client device from the first merchandise item.

3. The method of claim 1, further comprising:
in response to receiving the first identification data from the first client device, providing first merchandise information corresponding to the first merchandise item to the first client device.

4. The method of claim 3, wherein establishing the first association between the first merchandise item and the first account of the first client device further comprises:
receiving a user instruction from the first client device to save the first merchandise information; and
in response to the user instruction, storing the first merchandise information in association with the first user account of the first client device for future user retrieval from the first user account.

5. The method of claim 1, further comprising:
prior to generating the second identification data, receiving a user instruction from the first client device to generate the second identification data; and
in response to the user instruction, providing the second identification data to the first client device for display on the first client device.

6. The method of claim 5, wherein the second identification data is a 2D barcode, and the second client device acquires the 2D bar code by scanning the 2D barcode displayed on the first client device.

7. The method of claim 1, further comprising:
detecting an update on the first merchandise information for the first merchandise item;
in response to detecting the update, determining that the first merchandise item is associated with the first user account based on the first association; and
in response to the determining, providing the update to the first client device for future user retrieval from the first user account.

8. The method of claim 1, further comprising:
receiving a message regarding the first merchandise item from the second user account;
in response to receiving the message, determining that the first merchandise item is associated with the first user account based on the first association;
in accordance with the determining, forwarding the message to the first user account.

9. The method of claim 1, further comprising:
receiving a user instruction from the first client device to purchase the first merchandise item; and
in response to receiving the user instruction, coordinating a payment transaction for the purchase of the first merchandise item using a payment account associated with the first user account.

10. The method of claim 9, further comprising:
in response to receiving the user instruction, determining that the first merchandise item and the first user account is associated with the second user account based on the second association; and
in response to the determining, registering a credit for a second user of the second user account for the sale of the first merchandise item to the first user.

11. A server for pushing merchandise information, the server comprising:
one or more processors; and
memory having instructions stored thereon, the instructions, when executed by the one or more processors, cause the processors to perform operations comprising:
receiving first identification data from a first client device, wherein the first identification data is acquired by the first client device from a first merchandise item;
establishing a first association between the first merchandise item and a first user account of the first client device, the first association indicating an expressed interest of a first user of the first client device in the first merchandise item;
generating second identification data for the first association between the first user account and the first merchandise item;
receiving the second identification data from a second client device; and
in response to receiving the second identification data from the second client device, establishing a second association between a second user account of the second client device, the first merchandise item, and the first user account, the second association indicating an expressed interaction between a second user of the second client device and the first user with regard to the first merchandise item.

12. The server of claim 11, wherein the operations further comprise:
prior to generating the second identification data, receiving a user instruction from the first client device to generate the second identification data; and
in response to the user instruction, providing the second identification data to the first client device for display on the first client device.

13. The server of claim 11, wherein the operations further comprise:
detecting an update on the first merchandise information for the first merchandise item;
in response to detecting the update, determining that the first merchandise item is associated with the first user account based on the first association; and
in response to the determining, providing the update to the first client device for future user retrieval from the first user account.

14. The server of claim 11, wherein the operations further comprise:
receiving a message regarding the first merchandise item from the second user account;
in response to receiving the message, determining that the first merchandise item is associated with the first user account based on the first association;
in accordance with the determining, forwarding the message to the first user account.

15. The server of claim 11, wherein the operations further comprise:
receiving a user instruction from the first client device to purchase the first merchandise item;
in response to receiving the user instruction, coordinating a payment transaction for the purchase of the first merchandise item using a payment account associated with the first user account;
in response to receiving the user instruction, determining that the first merchandise item and the first user account is associated with the second user account based on the second association; and
in response to the determining, registering a credit for a second user of the second user account for the sale of the first merchandise item to the first user.

16. A non-transitory computer-readable medium having instructions stored thereon, the instructions, when executed by one or more processors, cause the processors to perform operations comprising:
receiving first identification data from a first client device, wherein the first identification data is acquired by the first client device from a first merchandise item;
establishing a first association between the first merchandise item and a first user account of the first client device, the first association indicating an expressed interest of a first user of the first client device in the first merchandise item;
generating second identification data for the first association between the first user account and the first merchandise item;
receiving the second identification data from a second client device; and
in response to receiving the second identification data from the second client device, establishing a second association between a second user account of the second client device, the first merchandise item, and the first user account, the second association indicating an expressed interaction between a second user of the second client device and the first user with regard to the first merchandise item.

17. The computer-readable medium of claim 16, wherein the operations further comprise:
prior to generating the second identification data, receiving a user instruction from the first client device to generate the second identification data; and
in response to the user instruction, providing the second identification data to the first client device for display on the first client device.

18. The computer-readable medium of claim 16, wherein the operations further comprise:
detecting an update on the first merchandise information for the first merchandise item;
in response to detecting the update, determining that the first merchandise item is associated with the first user account based on the first association; and
in response to the determining, providing the update to the first client device for future user retrieval from the first user account.

19. The computer-readable medium of claim 16, wherein the operations further comprise:
receiving a message regarding the first merchandise item from the second user account;
in response to receiving the message, determining that the first merchandise item is associated with the first user account based on the first association;
in accordance with the determining, forwarding the message to the first user account.

20. The computer-readable medium of claim 16, wherein the operations further comprise:
receiving a user instruction from the first client device to purchase the first merchandise item;
in response to receiving the user instruction, coordinating a payment transaction for the purchase of the first merchandise item using a payment account associated with the first user account;
in response to receiving the user instruction, determining that the first merchandise item and the first user account is associated with the second user account based on the second association; and
in response to the determining, registering a credit for a second user of the second user account for the sale of the first merchandise item to the first user.
